(19) United States
(12) Patent Application Publication
(10) Pub. No.: US 2026/0104375 A1
(43) Pub. Date: Apr. 16, 2026

(54) THERMAL IMAGING-BASED STATE ESTIMATION OF A STEFAN PROBLEM WITH APPLICATION TO CELL THAWING

(71) Applicant: Massachusetts Institute of Technology, Cambridge, MA (US)

(72) Inventors: Richard D. Braatz, Arlington, MA (US); Allan S. Myerson, Cambridge, MA (US); George Barbastathis, Boston, MA (US); Prakitr Srisuma, Cambridge, MA (US); Moo Sun Hong, Cambridge, MA (US); Ajinkya Pandit, Cambridge, MA (US); Qihang Zhang, Cambridge, MA (US)

(21) Appl. No.: 19/117,306

(22) PCT Filed: Oct. 18, 2023
(86) PCT No.: PCT/US2023/035395

§ 371 Date: Mar. 31, 2025

Related U.S. Application Data
(60) Provisional application No. 63/379,987, filed on Oct. 18, 2022.

(51) Int. Cl. G01N 25/04; G01N 1/44; G06T 7/00; G06T 7/73

(52) U.S. Cl. CPC G01N 25/04; G01N 1/44; G06T 7/0014; G06T 7/74; G06T 2207/30024

(57) ABSTRACT

Devices and methods for controlling a phase transition of a sample are provided. The device includes a heat transfer device adapted to be thermally connected with a sample, where the sample has a first phase and a second phase, with the sample being initially in the first phase; an image acquisition module adapted to acquire an image of the sample; and a control system, operably connected to the heat transfer device and the image acquisition module. The control system is configured to, while a termination condition is not met: cause heat transfer between the heat transfer device and the sample, thereby causing a phase transition of the sample from the first phase to the second phase; cause the acquisition module to acquire the image of the sample; based on the image of the sample, determine the position of a boundary between the first phase and the second phase of the sample; and based on the determined position of the boundary, determine whether the termination condition is met.

### BACKGROUND

The classical Stefan problem is a heat transfer problem that describes the evolution of a moving interface in a freezing or melting process [1, 2]. The one-phase Stefan problem assumes the temperature of either liquid or solid to be constant at the melting/freezing point, whereas the two-phase Stefan problem considers temperature variations in both phases [3].

The Stefan problem has been explored for a variety of boundary conditions, dimensions, coordinate systems, and other relevant assumptions [1, 4, 5].

The Stefan problem arises in industrial and natural systems, e.g., casting [5], polymorphous materials formation [6], alloy formation [7, 8], glaciation [9], and phase change materials [10]. Stefan problems are also encountered in various biomedical scenarios including freezing and thawing of biological tissue during cryosurgery [11-13] and during cryopreservation [14].

Many analytical and numerical techniques have been proposed for various types of Stefan problems. Exact analytical solutions to some specific Stefan problems have been derived for both one-phase [15] and two-phase systems [16, 17]. The analytical solutions typically involve Bessel functions, the error function, and/or infinite series. Numerical techniques have been developed for handling more general Stefan problems. Finite difference, volume, and element methods have been implemented on one- and two-phase Stefan problems [4, 18-25].

State estimation and/or control of Stefan problems have also been investigated, including an observer-based backstepping-based control design for the one-phase Stefan problem [26], a full-state feedback control design for the two-phase Stefan problem for the continuous casting of steel [27], and real-time estimation of an unmeasured heat flux at a boundary [28]. Applications to cell thawing, on the other hand, are very limited. Optimization of freezing and thawing has been shown to improve the viability and quality of the resulting cells [29-31], and thus successful cryopreservation and cell thawing preceding injection are crucial in cell therapy [30, 32]. While some studies have analyzed and modeled cell thawing/freezing [11-14], real-time state estimation and control based on a thawing/freezing model that simulates the solid-liquid interface have not been available.

The present application presents a new approach for state estimation of Stefan problems and implements the approach to cell thawing, a process used in cell therapy preceding injection. The Stefan problem is solved by a combination of the moving grid finite difference method and the numerical method of lines. A Luenberger observer is proposed for estimation of the spatially distributed states by using the information from real-time thermal imaging of the vial. The observer design is demonstrated in simulations and experiments.

### SUMMARY

This Summary introduces a selection of concepts in simplified form that are described further below in the Detailed Description. This Summary neither identifies key or essential features, nor limits the scope, of the claimed subject matter.

In a first example embodiment, the present invention is a device, comprising: a heat transfer device, adapted to be thermally connected with a sample, the sample having a first phase and a second phase, with the sample being initially in the first phase, an image acquisition module adapted to acquire an image of the sample, and a control system operably connected to the heat transfer device and the image acquisition module, wherein the control system is configured to, while a termination condition is not met: cause heat transfer between the heat transfer device and the sample, thereby causing a phase transition of the sample from the first phase to the second phase; cause the acquisition module to acquire the image of the sample, based on the image of the sample, determine the position of a boundary between the first phase and the second phase of the sample; and based on the determined position of the boundary, determine whether the termination condition is met.

In a second example embodiment, the present invention is a method for controlling a phase transition of a sample, the method comprising: thermally connecting a sample with a heat transfer device, the sample having a first phase and a second phase, with the sample being initially in the first phase; operating a control system while a termination condition is not met, the control system being operably connected to the heat transfer device and an image acquisition module, wherein operating the control module comprises: causing heat transfer between the heat transfer device and the sample, thereby causing a phase transition from the first phase to the second phase; causing the image acquisition module to acquire an image of the sample; based on the image of the sample, determining the position of a boundary between the first phase and the second phase of the sample; based on the determined position of the boundary, determining whether the termination condition is met.

The following Detailed Description references the accompanying drawings which form a part this application, and which show, by way of illustration, specific example implementations. Other implementations may be made without departing from the scope of the disclosure.

### BRIEF DESCRIPTION OF THE DRAWINGS

FIG. 1 depicts experimental system for cell thawing. A thermal imaging camera continuously measures the spatial temperature field during heating of a vial containing cells, according to embodiments of the present disclosure.

FIG. 2 depicts cell thawing with radial symmetry. The radial coordinate is r, the radius of the vial is b, and the radial position of the moving solid-liquid interface is s(t), according to embodiments of the present disclosure.

FIG. 3 depicts discretization of the moving grid domain, according to embodiments of the present disclosure.

FIG. 4 depicts evolution of the solid-liquid interface in the moving grid domain, according to embodiments of the present disclosure.

FIG. 5 depicts time evolution of the radial position of the solid-liquid interface predicted by the first-principles model for (a) four values of the vial radius with the heater temperature of 37° C. and (b) four values of the heater temperature with the vial radius of 5 mm. The initial temperature of the solid phase is uniform at −80 C, and the initial temperature of the liquid phase is uniform at the melting point temperature of −2 C, according to embodiments of the present disclosure.

FIG. 6 depicts spatiotemporal evolution of the temperatures of the (a) solid and (b) liquid phases for the default vial radius (5 mm) and heater temperature (37° C.). The initial temperature of the solid phase is uniform at 80° C., and the initial temperature of the liquid phase is uniform at the melting point temperature of 2° C. The normalized position is used to help visualize the plots easily, according to embodiments of the present disclosure.

FIG. 7 depicts spatiotemporal evolution of the temperature of the solid and liquid phases in the original coordinates for a vial of radius 5 mm and the heater temperature of 37° C. The initial temperature of the solid phase is uniform at −80° C., and the initial temperature of the liquid phase is uniform at the melting point temperature of −2° C., according to embodiments of the present disclosure.

FIG. 8 depicts time evolution of the measured and predicted interface position for the vial radius of 5 mm and heater temperature of 37° C. The first-principles model is initialized by the measured initial temperatures and interface position, according to embodiments of the present disclosure.

FIG. 9 depicts simulated time evolution of the actual, measured, and estimated position of the solid-liquid interface for values of the observer gain (a) L₃=½, (b) L₃=2, (c) L₃=5, and (d) L₃=15, noise-free case. The observer gains L₁ and L₂ are 1. The vial radius is 5 mm, and the heater temperature is 37° C. The initial interface position of the observer (red curve) is different from the actual initial state (black curve) to assess convergence. The output (blue curve) and actual state (black curve) are identical as there is no measurement noise, according to embodiments of the present disclosure.

FIG. 10 depicts simulated time evolution of the actual, measured, and estimated position of the solid-liquid interface for values of the observer gain (a) L₃=½, (b) L₃=2, (c) L₃=5, and (d) L₃=15, with random measurement noise with the maximum of 5° C. and minimum of 5° C. given by the accuracy of the thermal imaging camera [33]. The observer gains L₁ and L₂ are 1. The vial radius is 5 mm, and the heater temperature is 37° C. The initial interface position of the observer (red curve) is different from the actual initial state (black curve) to assess convergence, according to embodiments of the present disclosure.

FIG. 11 depicts time evolution of the measured and estimated position of the solid-liquid interface for values of the observer gain (a) L₃=2, (b) L₃=3, (c) L₃=4, and (d) L₃=5. The observer gains L₁ and L₂ are 1. The vial radius is 5 mm, and the heater temperature is 37° C. The initial interface position of the observer is different from the initial measured value to demonstrate convergence; in practice, this value can be set to the initial measured value, according to embodiments of the present disclosure.

FIG. 12 depicts time evolution of the (a) estimated position of the solid-liquid interface when both temperature and interface position are measurable, and only the interface position can be measured and (b) pointwise difference between the results obtained from both approaches. The observer gain L₃ is 5 in all cases with L₁=L₂=1 for the case with temperature measurements (full states). Other parameters and data are the same as those in FIG. 11, according to embodiments of the present disclosure.

FIG. 13 depicts time evolution of the measured, estimated, and predicted interface position for the vial radius of 5 mm and heater temperature of 37° C. The observer gains are L₁=L₂=1 and L₃=5, taking a complete set of measurements (temperature and interface position). The first-principles model and observer are initialized by the measured initial temperatures and interface position, according to embodiments of the present disclosure.

FIG. 14 depicts time evolution of the estimated and measured interface position from four experimental runs for the vial radius of 5 mm and heater temperature of 37° C. The observer gains are L₁=L₂=1 and L₃=5, taking a complete set of measurements (temperature and interface position). The observer is initialized by the measured initial temperatures and interface position, according to embodiments of the present disclosure.

FIG. 15 depicts time evolution of the estimated and measured interface position from four experimental runs for the vial radius of 5 mm and heater temperature of 37° C. The observer gains are L₁=L₂=1 and L₃=5, taking the same set of measurements as in FIG. 14 but with stronger sensor noise. The observer is initialized by the measured initial temperatures and interface position, according to embodiments of the present disclosure.

FIG. 16 depicts discretization of the fixed grid domain, according to embodiments of the present disclosure.

FIG. 17 depicts evolution of the solid-liquid interface in the fixed grid domain, according to embodiments of the present disclosure.

FIG. 18 depicts spatial temperature fields recorded by the thermal imaging camera, according to embodiments of the present disclosure.

FIG. 19 depicts a vertical moving interface, according to embodiments of the present disclosure.

FIG. 20 depicts an exemplary system for controlling a phase transition of a sample, according to embodiments of the present disclosure.

FIG. 21 depicts an exemplary sample having a first phase, a second phase, and a boundary of the phases, according to embodiments of the present disclosure.

FIG. 22 depicts an exemplary flow diagram for controlling a phase transition of a sample, according to embodiments of the present disclosure.

FIG. 23 depicts an exemplary variables and variable profiles during a phase transition of a sample, according to embodiments of the present disclosure.

FIG. 24 depicts a flow chart of an exemplary method for controlling a phase transition of a sample, according to embodiments of the present disclosure.

FIG. 25 depicts a schematic of an example of a computing node according to various embodiments of the present disclosure.

### DETAILED DESCRIPTION

Reference numbers in brackets “[ ]” herein refer to the corresponding literature listed in the Bibliography which forms a part of this Specification, and the literature is incorporated by reference herein.

### Theoretical Background and Problem Formulation

### Cell Thawing Process

This article considers cell thawing, a process used in cell therapy before cells are introduced to the patients. Prior to thawing, cryopreservation is used to temporarily store the cells. The cells are frozen at low temperature (around 80° C.) to preserve their function, with the system being a single solid phase (consisting of cells, ice, and cryoprotection molecules) at its initial state. During thawing, energy is continuously supplied by a heating plate to thaw the material in each vial. When the mass fraction of frozen material decreases to about 5%, the vial is removed, and the cells are taken to the patient to be injected into the patient's body. The amount of frozen material left in the vial is specified so that all the vial contents are fluid by the time that the cells are injected into the patient; the small amount of frozen material keeps the aqueous solution from warming before injection.

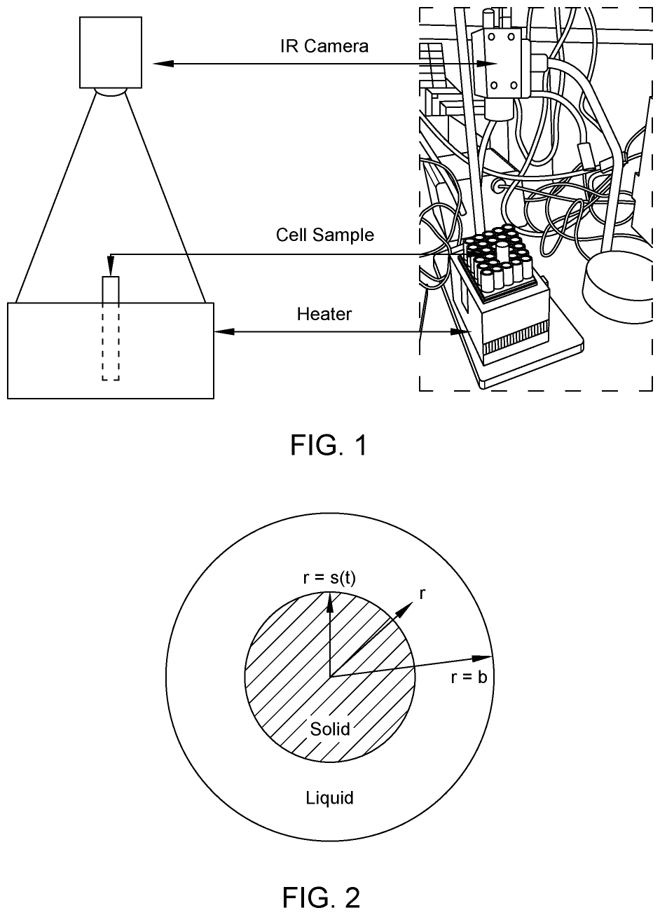

Our experimental setup consists of a vial with the radius of 5 mm and height of 43 mm initially containing biological cells frozen in ice, a heating plate whose temperature is specified (e.g., fixed at 37° C.), and a thermal imaging camera FLIR A35sc [33] for monitoring the spatially varying temperature (FIG. 1). This setup combines commercial cell thawing equipment with a thermal imaging camera to provide real-time measurements for estimation and control.

Accurate prediction of the mass fraction of the solid can help achieve the best cell condition before these cells are injected, which directly benefits the patient. To track the mass fraction of the solid, a model for predicting the solid-liquid interface which directly relates to the volume of solid (and liquid) in the system is proposed. Considering the vial shape, the model is defined and formulated in cylindrical coordinates (r, θ, z). As heat flow is primarily in the radial direction, the Stefan problem can be simplified to be in the radial dimension (FIG. 2).

### Energy Conservation

The energy conservation equation can be written as [2]

$$ρ C \text{?} \frac{DT}{Dt} = - ∇ \text{?} q - ( \frac{\partial \text{?} n T}{\partial \text{?} n T} ) \text{?} \frac{Dp}{Dt} - τ \text{?} v \text{?} \qquad ( 1 )$$

$$\text{?} \text{indicates text missing or illegible when filed}$$

where T is the temperature, p is the pressure, q is the heat flux governed by Fourier's law of heat conduction, v is the velocity, τ is the shear stress, t is time, ρ is the density, and Cₚ is the heat capacity. In cell thawing/freezing modeling, heat conduction is considered dominant compared to other heat transfer modes [14, 34]. In our system, heat transfer can be omitted in the θ direction due to the vial being radially symmetric and in the z direction due to the low surface area of the bottom of the vial relative to the sides. Furthermore, the viscous dissipation term (τ: v) is much smaller than the other terms and can be neglected. In addition, the cells are relatively small compared with the length scales of the vial and create negligible biochemical reactions at the operating conditions, and so do not influence any phenomena in the system. Lastly, the liquid and solid have nearly constant thermal properties. Incorporating all these assumptions and substituting Fourier's law of heat conduction into (1) result in ∇

$$\frac{1}{α} \frac{\partial T}{\partial t} = \frac{{\partial }^{2} T}{\partial {r}^{2}} + \frac{1}{r} \frac{\partial T}{\partial r} \text{?} \qquad ( 2 )$$

$$\text{?} \text{indicates text missing or illegible when filed}$$

where α denotes the thermal diffusivity (α=k), and k is the thermal conductivity. The subscripts 1 and 2 denote the solid and liquid phases, respectively. Hence, the governing equations for the solid region (0<r<s) and liquid region (s<r<b) are

$$\frac{1}{{α}_{1}} \frac{\partial {T}_{1}}{\partial t} = \frac{{\partial }^{2} {T}_{1}}{\partial {r}^{2}} + \frac{1}{r} \frac{\partial {T}_{1}}{\partial r} , \qquad ( 3 )$$

$$\frac{1}{{α}_{2}} \frac{\partial {T}_{2}}{\partial t} = \frac{{\partial }^{2} {T}_{2}}{\partial {r}^{2}} + \frac{1}{r} \frac{\partial {T}_{2}}{\partial r} . \qquad ( 4 )$$

Define the times when thawing starts and completes as tₛ and tₗ, respectively. In a thawing problem where the initial state is pure solid, the solid domain exists when t<tₗ, while the liquid domain exists when t>tₛ. For tₛ<t<tₗ, both phases are present.

### Boundary Conditions

This section describes the boundary conditions for the model of the cell thawing system.

### Outer Boundary Condition

The outer boundary of the vial, which is heated by the heating plate, satisfies the Robin boundary condition

$$\{ \begin{matrix}{k}_{1} \frac{\partial {T}_{1}}{\partial r} = U ( {T}_{0} - {T}_{1} ) & for t \leq t \text{?} , \\ {k}_{2} \frac{\partial {T}_{2}}{\partial r} = U ( {T}_{0} - {T}_{2} ) & for t > t \text{?} ,\end{matrix} \qquad ( 5 )$$

$$\text{?} \text{indicates text missing or illegible when filed}$$

at r=b, where T₀ is the fixed heater temperature, and U is the overall heat transfer coefficient which takes into account the heat transfer resistance due to the cell vial thickness and the air gap between the cell vial and the heater. The heat transfer coefficient depends on multiple factors, including the unknown small gap between the outer wall of the vial and the heating plate, and is estimated from experimental data.

### Symmetry Condition

Symmetry of a cylinder implies the boundary condition

$$\{ \begin{matrix}\frac{\partial {T}_{1}}{\partial r} = 0 & for t < t \text{?} , \\ \frac{\partial {T}_{2}}{\partial r} = & for t \geq t \text{?} ,\end{matrix} \qquad ( 6 )$$

$$at r = 0.$$

$$\text{?} \text{indicates text missing or illegible when filed}$$

### Stefan Conditions

When tₛ<t<tₗ, heat transfer associated with thawing at the moving solid-liquid interface r=s is described by the Stefan conditions

$${T}_{1} = {T}_{2} = T \text{?} \qquad ( 7 )$$

$$ρΔ H \text{?} \frac{ds}{dt} = {k}_{1} \frac{\partial {T}_{1}}{\partial r} - {k}_{2} \frac{\partial {T}_{2}}{\partial r} , \qquad ( 8 )$$

$$\text{?} \text{indicates text missing or illegible when filed}$$

where ΔH_{f} is the latent heat of fusion, and Tₘ is the melting point. The first condition requires the temperature at the interface s to be Tₘ. The second condition is the energy balance associated with thawing at the moving interface. For the density p, past publications have used the density of the solid [16], the density of the liquid [22], or assumed that both phases have the same density [35]. The solid and liquid densities are not largely different, so any of these densities gives similar results. In our case, it is more convenient to use the density of the solid (ρ₁) because the equations are nondimensionalized with respect to the solid phase.

### Dimensionless Quantities and Equations

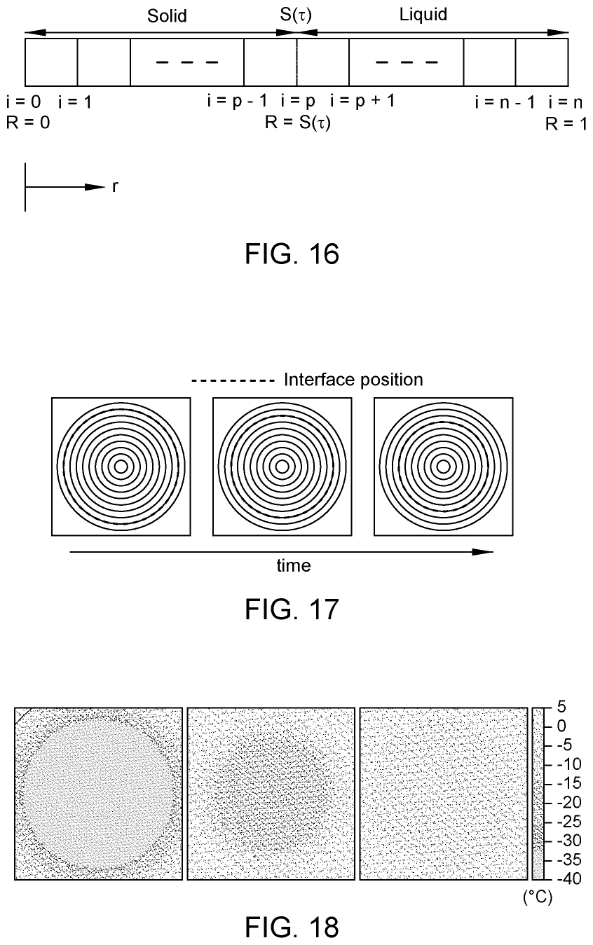

In transport phenomena, it is common to solve model equations in dimensionless form to minimize the number of parameters in the final problem formulation. A technique of nondimensionalization used in this work is appropriate for moving grids, i.e., the space between each grid point is varied with respect to the moving interface. This technique has been applied in pharmaceutical process modeling [36], and its concept is similar to the variable space grid method that has been used to solve some one-phase Stefan problems [19, 21, 23]. An alternative nondimensionalization technique which is more common and produces fixed grids is given and discussed in FIG. 16.

For two-phase problems, define the dimensionless variables and constants

$${R}_{1} = \frac{r}{s} , \qquad ( 9 )$$

$${R}_{2} = \frac{r - s}{b - s} , \qquad ( 10 )$$

$$r = \frac{{α}_{1} t}{{b}^{2}} , \qquad ( 11 )$$

$${Θ}_{1} = \frac{{T}_{1} - {T}_{m}}{{T}_{0} - {T}_{m}} , \qquad ( 12 )$$

$${Θ}_{2} = \frac{{T}_{2} - {T}_{m}}{{T}_{0} - {T}_{m}} , \qquad ( 13 )$$

$$S = \frac{s}{b} , \qquad ( 14 )$$

$$Ste = \frac{{C}_{p 1} ( {T}_{0} - {T}_{m} )}{Δ {H}_{f}} , \qquad ( 15 )$$

$${α}_{0} = \frac{{α}_{2}}{{α}_{1}} , \qquad ( 16 )$$

$${k}_{0} = \frac{{k}_{2}}{{k}_{1}} \qquad ( 17 )$$

$${U}_{0} = \frac{Ub}{{k}_{2}} , \qquad ( 18 )$$

where Ste is the Stefan number. R₁ and R₂ are used to denote the radial position within the solid and the radial position within the liquid, respectively. Both R₁ and R₂ depend on the radial position of the moving interface s, which results in moving grids when the equations are discretized. From (9), R₁=0 at the center r=0, and R₁=1 at the solid-liquid interface r=s. Similarly, from (10), R₂=0 at the solid-liquid interface s, and R₂=1 at the outer boundary r=b. This type of nondimensionalization has several advantages described below.

With these dimensionless variables, applying the chain rule to all the derivative terms in (3) and (4) results in

$$\frac{\partial {T}_{1}}{\partial \text{?}} = \frac{{α}_{1} ( {T}_{0} - {T}_{m} )}{{b}^{2}} \frac{\partial {Θ}_{1}}{\partial \text{?}} - \frac{{α}_{1} {R}_{1} ( {T}_{0} - {T}_{m} )}{{b}^{2} S} \frac{\partial {Θ}_{1}}{\partial {R}_{1}} \frac{dS}{d \text{?}} , \qquad ( 19 )$$

$$\frac{\partial {T}_{1}}{\partial \text{?}} = \frac{{T}_{0} - {T}_{m}}{bS} \frac{\partial {Θ}_{1}}{\partial {R}_{1}} , \qquad ( 20 )$$

$$\frac{{\partial }^{2} {T}_{1}}{\partial {\text{?}}^{2}} = \frac{{T}_{0} - T \text{?}}{{b}^{2} {S}^{2}} \frac{{\partial }^{2} {Θ}_{1}}{\partial R \text{?}} , \qquad ( 21 )$$

$$\frac{\partial {T}_{2}}{\partial \text{?}} = \frac{{α}_{1} ( {T}_{0} - {T}_{m} )}{{b}^{2}} \frac{\partial {Θ}_{2}}{\partial \text{?}} - \frac{{α}_{1} ( 1 - {R}_{2} ) ( {T}_{0} - {T}_{m} )}{{b}^{2} ( 1 - S )} \frac{\partial {Θ}_{2}}{\partial {R}_{2}} \frac{dS}{d \text{?}} , \qquad ( 22 )$$

$$\frac{\partial {T}_{2}}{\partial \text{?}} = \frac{{T}_{0} - {T}_{m}}{b ( 1 - S )} \frac{\partial {Θ}_{2}}{\partial {R}_{2}} , \qquad ( 23 )$$

$$\frac{{\partial }^{2} {T}_{2}}{\partial {\text{?}}^{2}} = \frac{{T}_{0} - {T}_{m}}{{{b}^{2} ( 1 - S )}^{2}} \frac{\partial {Θ}_{2}}{\partial R \text{?}} . \qquad ( 24 )$$

$$\text{?} \text{indicates text missing or illegible when filed}$$

Substituting (19)-(24) into (3) and (4) results in the nondimensionalized partial differential equations (PDEs)

$$\frac{\partial {Θ}_{1}}{\partial r} = \frac{1}{{S}^{2}} \frac{{\partial }^{2} {Θ}_{1}}{\partial R \text{?}} + \frac{1}{{S}^{2} {R}_{1}} \frac{\partial {Θ}_{1}}{\partial {R}_{1}} + \frac{{R}_{1}}{S} \frac{dS}{d \text{?}} \frac{\partial {Θ}_{1}}{\partial {R}_{1}} , \qquad ( 25 )$$

$$\frac{1}{{α}_{0}} \frac{\partial {Θ}_{2}}{\partial \text{?}} = \frac{1}{{( 1 - S )}^{2}} \frac{{\partial }^{2} {Θ}_{2}}{\partial R \text{?}} + \frac{1}{( 1 - S ) ( S + {R}_{2} ( 1 - S ) )} \frac{\partial {Θ}_{2}}{\partial {R}_{2}} + \frac{1 - {R}_{2}}{{α}_{0} ( 1 - S )} \frac{dS}{d \text{?}} \frac{\partial {Θ}_{2}}{\partial {R}_{2}} \qquad ( 26 )$$

$$\text{?} \text{indicates text missing or illegible when filed}$$

where (25) is for the solid region (0<R₁<1), and (26) is for the liquid region (0<R₂<1). The Robin boundary condition is

$$\{ \begin{matrix}\frac{1}{S} ( \frac{\partial {θ}_{1}}{\partial {R}_{1}} ) = {U}_{0} {k}_{0} ( 1 - {θ}_{1} ) & for τ \leq \text{?} , at {R}_{1} = 1 , \\ \frac{1}{1 - S} ( \frac{\partial {θ}_{2}}{\partial {R}_{2}} ) = {U}_{0} ( 1 - {θ}_{2} ) & for τ > \text{?} , at {R}_{2} = 1 ,\end{matrix} \qquad ( 27 )$$

$$\text{?} \text{indicates text missing or illegible when filed}$$

where τₛ is the dimensionless time evaluated at tₛ. For the symmetry condition,

$$\{ \begin{matrix}\frac{1}{S} ( \frac{\partial {θ}_{1}}{\partial {R}_{1}} ) = 0 & for τ < {τ}_{s} , at {R}_{1} = 0 \text{?} \\ \frac{1}{1 - S} ( \frac{\partial {θ}_{2}}{\partial {R}_{2}} ) = 0 & for τ \geq η , at {R}_{2} = 0 \text{?}\end{matrix} \qquad ( 28 )$$

$$\text{?} \text{indicates text missing or illegible when filed}$$

where τₗ is the dimensionless time evaluated at tₗ. The Stefan conditions at R₁=1 and R₂=0 are

$${θ}_{1} = {θ}_{2} = 0 , \qquad ( 29 )$$

$$\frac{1}{Ste} \frac{dS}{d \text{?}} = \frac{1}{S} \frac{\partial {θ}_{1}}{\partial {R}_{1}} - \frac{{k}_{0}}{1 - S} \frac{\partial {θ}_{2}}{\partial {R}_{2}} . \qquad ( 30 )$$

$$\text{?} \text{indicates text missing or illegible when filed}$$

This transformation results in nonlinear PDEs.

### Numerical Methods

To produce moving grids, the radial positions are defined as

$${R}_{1} = i Δ R \text{?} \qquad ( 31 )$$

$${R}_{2} = j Δ R \text{?} \qquad ( 32 )$$

$$\text{?} \text{indicates text missing or illegible when filed}$$

where i and j are the integer indices for discretization, ΔR=1 n, and n is the number of grid points. From (9) and (31), i=0 and R₁=0 at the center r=0, and i=n and R₁=1 at the solid-liquid interface r=s, respectively. Similarly, (10) and (32) imply that j=0 and R₂=0 at the solid-liquid interface s, and j=n and R₂=1 at the outer boundary r=b.

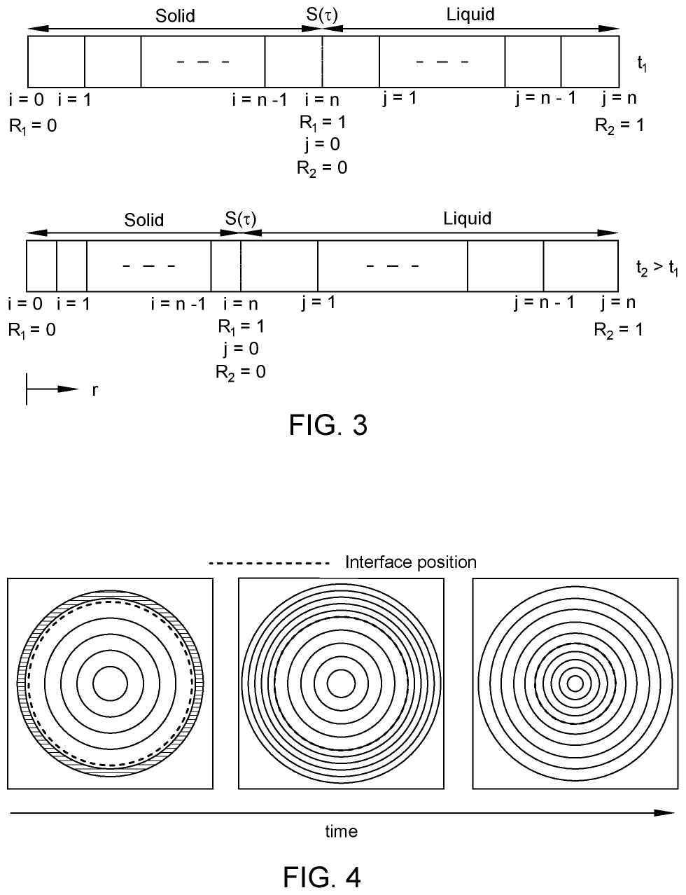

The transformation and discretization explained above allow grid size to be varied with the position of a moving interface to capture the system behavior accurately. As the solid-liquid interface moves, the size of grids in the solid phase decreases, while that in the liquid phase increases (FIGS. 3 and 4). In addition, the number of grid points in each phase is constant irrespective of the interface position. This property ensures that the number of grids is always sufficient at any stage of thawing. Moreover, state estimation and process control are simplified because the number of states is constant in both regions all the time.

Neither of the aforementioned properties can be achieved if the problem is solved in a fixed grid domain, and that is why the moving grid approach is superior to the typical fixed grid approach in nearly all aspects. The only drawback of the moving grid approach is that it is significantly more complicated in terms of mathematical derivation and computation.

The numerical method of lines [37] is applied for discretization. This technique discretizes the spatial derivatives only, converting each PDE into a system of ordinary differential equations (ODEs). The resulting ODEs can be solved by available solvers such as ode45 and ode15s in MATLAB. These ODE solvers employ highly efficient adaptive time stepping procedures, which is computationally efficient, especially when the time step needs to be small to achieve numerical accuracy for some of the time.

Discretizing the governing PDEs (25) and (26) using the central difference (second order of accuracy) approximation and the numerical method of lines results in

$$\frac{d ( {θ}_{1} ) \text{?}}{d \text{?}} = \frac{1}{{S}^{2}} ( \frac{( {θ}_{1} ) \text{?} - 2 ( {θ}_{1} ) \text{?} + ( {θ}_{1} ) \text{?}}{( Δ {R}^{2} )} ) + \frac{1}{{S}^{2} ( i Δ R )} ( \frac{( {θ}_{1} ) \text{?} - ( {θ}_{1} ) \text{?}}{( 2 Δ {R}^{2} )} ) + \frac{i Δ R}{S} ( \frac{( {θ}_{1} ) \text{?} - ( {θ}_{1} ) \text{?}}{( 2 Δ R )} ) ( \frac{dS}{d \text{?}} ) , \qquad ( 33 )$$

$$\frac{d ( {θ}_{2} ) \text{?}}{d \text{?}} = \frac{\text{?}}{{( 1 - S )}^{2}} ( \frac{( {θ}_{2} ) \text{?} - 2 ( {θ}_{2} ) \text{?} + ( {θ}_{2} ) \text{?}}{( Δ {R}^{2} )} ) + ( \frac{\text{?}}{( 1 - S ) ( S + j Δ R ( 1 - S ) )} ) ( \frac{( {θ}_{2} ) \text{?} - ( {θ}_{2} ) \text{?}}{2 Δ R} ) + \frac{1 - j Δ R}{1 - S} ( \frac{( {θ}_{2} ) \text{?} - ( {θ}_{2} ) \text{?}}{2 Δ R} ) ( \frac{dS}{d \text{?}} ) . \qquad ( 34 )$$

$$\text{?} \text{indicates text missing or illegible when filed}$$

The Robin boundary condition can be treated by applying the central difference scheme

$$\{ \begin{matrix}\frac{1}{S} ( \frac{{( {θ}_{1} )}_{n + 1} - {( {θ}_{1} )}_{n - 1}}{2 Δ R} ) = {U}_{0} {k}_{0} ( 1 - ( {θ}_{1} ) \text{?} ) & for τ \leq {τ}_{s} \text{?} \\ \frac{1}{1 - S} ( \frac{{( {θ}_{2} )}_{n + 1} - {( {θ}_{2} )}_{n - 1}}{2 Δ R} ) = {U}_{0} ( 1 - ( {θ}_{2} ) \text{?} ) & for τ > {τ}_{s} \text{?}\end{matrix} \qquad ( 35 )$$

$$\text{?} \text{indicates text missing or illegible when filed}$$

The temperatures at i, j=n+1 are not in the domain but can be eliminated by coupling D (35) with the governing PDEs at i, j=n. Several techniques are available for treating the symmetry condition. One technique is to first apply L'Hôpital's rule to the governing PDEs at R₁, R₂=0 to eliminate the singularity, and then discretize the PDEs as usual, resulting in

$$\{ \begin{matrix}\frac{{d ( {θ}_{1} )}_{0}}{d \text{?}} = \frac{4}{{S}^{2}} ( \frac{{( {θ}_{1} )}_{1} - {( {θ}_{1} )}_{0}}{{( Δ R )}^{2}} ) & for τ < η , \\ \frac{{d ( {θ}_{2} )}_{0}}{d \text{?}} = \frac{4 \text{?}}{{( 1 - S )}^{2}} ( \frac{{( {θ}_{2} )}_{1} - {( {θ}_{2} )}_{0}}{{( Δ R )}^{2}} ) & for τ \geq η .\end{matrix} \qquad ( 36 )$$

$$\text{?} \text{indicates text missing or illegible when filed}$$

This technique, which has been applied in many diffusion problems (e.g., [38, 39]), maintains the second order of accuracy at the singularity point r=0. For the Stefan conditions, the second-order forward and backward difference schemes can be applied to the liquid and solid sides, respectively, which gives

$$( {θ}_{1} ) \text{?} = ( {θ}_{2} ) \text{?} = 0 , \qquad ( 37 )$$

$$\frac{dS}{d \text{?}} = \frac{Ste}{S} ( \frac{3 ( {θ}_{1} ) \text{?}}{2 Δ R} - \frac{2 ( {θ}_{1} ) \text{?}}{Δ R} + \frac{( {θ}_{1} ) \text{?}}{2 Δ R} ) - \frac{{k}_{0} Ste}{1 - S} ( - \frac{3 {( {θ}_{2} )}_{0}}{2 Δ R} + \frac{2 {( {θ}_{2} )}_{1}}{Δ R} + \frac{{( {θ}_{1} )}_{2}}{2 Δ R} ) . \qquad ( 38 )$$

$$\text{?} \text{indicates text missing or illegible when filed}$$

During the thawing process (τₛ<τ<τₗ), all the above equations can be simplified to

$$\begin{matrix}\begin{matrix}\frac{{d ( {θ}_{1} )}_{0}}{d \text{?}} & {f}_{1} ( ( {θ}_{1} )\end{matrix} , {( {θ}_{1} )}_{1} , S ) & for i\end{matrix} = 0 , \qquad ( 39 )$$

$$\begin{matrix}\begin{matrix}\frac{d ( {θ}_{1} ) \text{?}}{d \text{?}} & {f}_{2} ( ( {θ}_{1} ) \text{?}\end{matrix} , ( {θ}_{1} ) \text{?} , ( {θ}_{1} ) \text{?} , S , \frac{dS}{d \text{?}} ) & for i\end{matrix} = 1 , … , n - 1 , \qquad ( 40 )$$

$$\begin{matrix}\begin{matrix}\frac{d ( {θ}_{2} ) \text{?}}{d \text{?}} & {f}_{3} ( ( {θ}_{2} ) \text{?}\end{matrix} , ( {θ}_{2} ) \text{?} , ( {θ}_{2} ) \text{?} , S , \frac{dS}{d \text{?}} ) & for j\end{matrix} = 1 , … , n - 1 , \qquad ( 41 )$$

$$\begin{matrix}\begin{matrix}\frac{d ( {θ}_{2} ) \text{?}}{d \text{?}} & {f}_{4} ( ( {θ}_{2} )\end{matrix} \text{?} , ( {θ}_{2} ) \text{?} , S ) & for j\end{matrix} = n , \qquad ( 42 )$$

$$\frac{dS}{d \text{?}} = {f}_{5} ( ( {θ}_{1} ) \text{?} , ( {θ}_{1} ) \text{?} , ( {θ}_{1} ) \text{?} {( {θ}_{2} )}_{0} , {( {θ}_{2} )}_{1} , {( {θ}_{2} )}_{2} , S ) , \qquad ( 43 )$$

$$\text{?} \text{indicates text missing or illegible when filed}$$

where f₁, f₂, f₃, f₄ and f₅ are the nonlinear functions, and (Θ₁)ₙ=(Θ₂)₀=0. The state vector x ∈R²ⁿ⁺¹ can be defined as

$$x = [ \begin{matrix}{x}_{1} \\ {x}_{2} \\ {x}_{3}\end{matrix} ] \text{?} \qquad ( 44 )$$

$$\text{?} \text{indicates text missing or illegible when filed}$$

where x₁ Rⁿ collects the temperature profile of the solid (Θ₁), from i=0 to i=n 1, x₂ Rⁿ collects the temperature profile of the liquid (Θ₂)ⱼ from j=1 to j=n, and x₃ is the interface position S. As a result, (39)-(43) can be written as

$$\frac{{dx}_{1}}{d \text{?}} = {F}_{1} ( x , u ) , \qquad ( 45 )$$

$$\frac{{dx}_{2}}{d \text{?}} = {F}_{2} ( x , u ) , \qquad ( 46 )$$

$$\frac{{dx}_{3}}{d \text{?}} = {F}_{3} ( x , u ) , \qquad ( 47 )$$

$$\text{?} \text{indicates text missing or illegible when filed}$$

where u is the vector of manipulated variables (e.g., heater temperature) and F₁ Rⁿ, F₂ Rⁿ, F₃ R denote the nonlinear functions of x and u. For implementation, (45)-(47) can be integrated using ode15s in MATLAB.

### State Estimation

This section describes the design of a state observer (aka state estimator) for the two-phase moving grid Stefan problem and its application to (45)-(47) for state estimation and control of the cell thawing process.

### Mathematical Structure of the Observer

Our primary aim of constructing an observer is to estimate the states in the moving grid model from the measurements. Well-known observers include the Luenberger observer, Kalman filter, high-gain observer, sliding-mode observer, and moving horizon estimator [40-43]. This work employs a Luenberger observer due to its simplicity and computational efficiency, which has resulted in widespread use in various applications [44-46].

Applying the Luenberger observer to our moving grid model (45)-(47) results in

$$\frac{{dx}_{1} \text{?}}{d \text{?}} = {F}_{1} ( x \text{?} , u ) + {L}_{1} ( y \text{?} - y \text{?} ) , \qquad ( 48 )$$

$$\frac{{dx}_{2} \text{?}}{d \text{?}} = {F}_{2} ( x \text{?} , u ) + {L}_{2} ( y \text{?} - y \text{?} ) , \qquad ( 49 )$$

$$\frac{{dx}_{3} \text{?}}{d \text{?}} = {F}_{3} ( x \text{?} , u ) + {L}_{3} ( y \text{?} - y \text{?} ) , \qquad ( 50 )$$

$$\text{?} \text{indicates text missing or illegible when filed}$$

where x\hat{ }₁, x\hat{ }₂, x\hat{ }₃ are the estimated states corresponding to x₁, x₂, x₃; L₁, L₂, L₃ are the Luenberger observer gains; y₁, y₂, y₃ are the measured outputs; and y\hat{ }₁, y\hat{ }₂, y\hat{ }₃ are the estimated outputs. The temperature profiles and interface position are approximated from the data provided by the thermal imaging camera (FIG. 1), so the output vectors are

$$y \text{?} = {C}_{1} x \text{?} \qquad ( 51 )$$

$$y \text{?} = {C}_{1} {x}_{1} + n \text{?} \qquad ( 52 )$$

$${y}_{2} \text{?} = {C}_{2} x \text{?} \qquad ( 53 )$$

$${y}_{2} = {C}_{2} {x}_{2} + n \text{?} \qquad ( 54 )$$

$$y \text{?} = C \text{?} \qquad ( 55 )$$

$$y \text{?} = C \text{?} + n \text{?} \qquad ( 56 )$$

$$\text{?} \text{indicates text missing or illegible when filed}$$

where C₁=C₂=Iₙ; Iₙ is the n n identity matrix; C₃ is 1; and n₁ Rⁿ, n₂ Rⁿ, n₃ R represent sensor noise.

The Luenberger observer is divided into three main parts: (48) estimates the temperature profile of the solid, (49) estimates the temperature profile of the liquid, and (50) estimates the interface position. This observer structure separates the states in three regions, each of which depends on a different set of parameters and measurement data, while respecting the coupling of the states in the moving grid model. The states of the observer in each region are updated by the corresponding measurements. In addition, this structure simplifies the selection of the observer gains. The control stopping criterion for cell thawing is the specified fraction of frozen material at the end of the thawing, which is directly related to the interface position rather than the temperature profiles within the solid and liquid phases. As such, the estimation of the interface position x₃=S is of primary interest, with the estimation of the other states of lesser importance.

### 4.2. Observer Design Procedure

The observer gains are selected to trade off sensitivity to measurement noise with speed of convergence of the state estimates. In (48)-(50), the observer gains L₁∈ [symbol] ^{n×n} and L₂∈ [symbol] ^{n×n} correspond to the number of grid points, while L₃ is a real scalar for the one interface position. The measurement noise in the infrared sensor is not spatially dependent, which suggests a parameterization with one degree of freedom in each phase:

$${L}_{1} = {L}_{1} {I}_{n} , \qquad ( 57 )$$

$${L}_{2} = {L}_{2} {I}_{n} , \qquad ( 58 )$$

where L₁ and L₂ are real scalars. With this parameterization, each spatial domain has one design parameter.

Each observer gain (L₁, L₂, and L₃) is selected to steer the states in the associated spatial domain in the first-principles model to the correct states given the measurement data. A higher gain results in faster convergence of the model states but increases the effects of measurement noise on the state estimates. The value of each gain is selected to converge the model states to the correct states as fast as possible without significantly polluting the state estimates by measurement noise.

In a linear, observable system, the Luenberger observer gain can be designed based on the eigenvalues of the closed-loop state equations [40]. In our nonlinear model, the observer gains are designed in a two-step procedure. The first step relies entirely on the first-principles model developed in (45)-(56), whereas the second step takes the data/measurement obtained from the real system into account. For convenience, the first step is denoted as model-based design and the latter as data-based design.

For the model-based design, the first-principles model and observer given by (45)-(56) are simulated to determine a range of observer gains that may have a practically reasonable con-vergence rate and filtering of measurement noise, without taking into account plant/model mismatch. After that step, the observer gains are refined by using the real data. For the data-based design, (52), (54), and (56) are replaced by the real measurement data, and the observer gains are varied. This step ensures that the design is based on the actual performance of the observer and tunes the observer gain to account for real measurement data and plant/model mismatch.

The model-based design allows for different models and noise profiles to be tested so that the resulting design can cover many possible scenarios, whereas the data-based design is primarily specific to the system where the real data are available. The former enables an initial observer design and performance assessment before the experimental system is set up. On the other hand, as the first-principles model is not perfect, and noise characteristics are not precisely known until the system is set up, the second step selects observer gains to account for that. The two-step approach to observer design saves time while providing an assurance of robustness in the final design.

### Results and Discussion

This section firstly describes the simulation results obtained from simulating the first-principles model and compares the results to the experimental data. Subsequently, the Luenberger observer design results derived following the procedure are presented. Finally, the results from implementing the complete model and observer to perform real-time state estimation and control of the cell thawing process are discussed. Table I lists the default parameters used in the simulations.

### Simulation Results and Model Validation

### Simulation Results

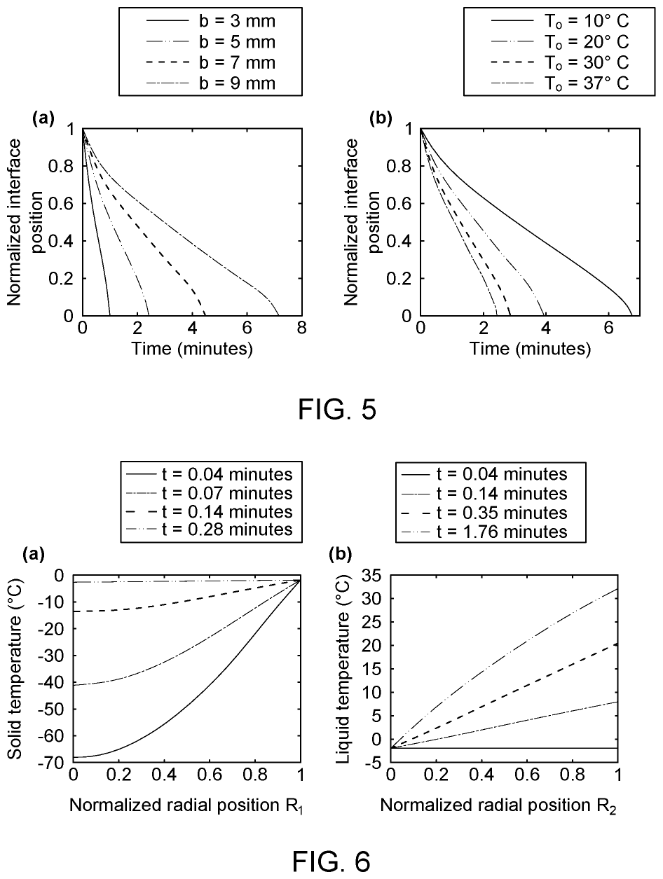

FIGS. 5-7 show the solid-liquid interface position and temperature profiles predicted by the first-principles model (45)-(47). From FIG. 5, the position of the solid-liquid interface decreases linearly at the beginning, and that decrease becomes slower as the driving force for heat transfer, i.e., the temperature difference between the heater and the vial, is lower. At the end of the process, the interface position drops rapidly, which is consistent with the increasing surface-area-to-volume ratio of the solid core. The time for complete thawing ranges from 1 minute to about 7 minutes, with an increase of a factor of seven for an increase in the vial radius of a factor of three (FIG. 5a). Increasing the heater temperature by 27° C. reduces the thawing time by about a factor of three (FIG. 5b).

The model predictions are consistent with typical thawing times in the literature. Previous studies have suggested a thawing temperature of 37° C. with thawing times of less than five minutes [29, 30]. A thawing time of about 3 minutes has been experimentally observed for a vial size similar to our vial of radius 5 mm [29].

For a vial of radius 5 mm and the standard heater temperature of 37° C., the temperature during thawing is nearly linear near the solid-liquid interface in the solid phase (FIG. 6a) and over the whole domain in the liquid phase (FIG. 6b). The spatial profile of the temperature in the solid deviates from linearity at its center (R₁=0), which is consistent with the radial symmetry condition. Once some of the heat has transferred to the center of the solid, the spatial profile retains a similar curved shape, eventually reaching the melting point once the solid core is sufficiently thin. The time scale of heat conduction in the liquid phase is about ten times slower than that of the solid phase (cf., FIG. 6ab).

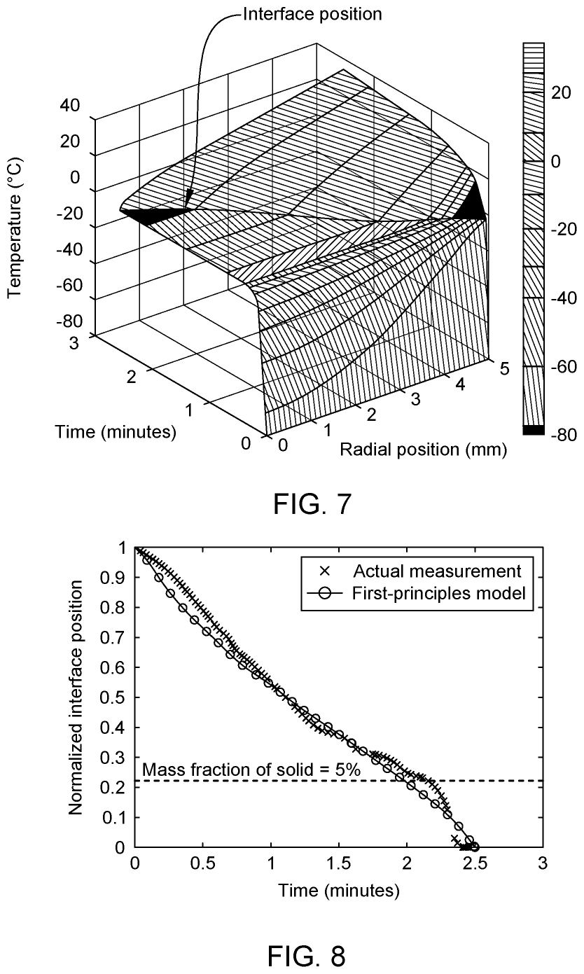

In FIG. 7, the temperature of the solid increases from 80° C. to the melting point of 2° C. within half a minute, so the solid temperature profile is flat most of the time. The liquid temperature at the inner glass surface of the vial (5 mm) evolves from its melting point to about 30° C. by the end of the thawing. The mesh spacing in FIG. 7 shows how the moving grid evolves during the simulation, i.e., the grid size in each domain varies as the interface position changes, with fine spatial resolution in the liquid phase near the start and in the solid phase near the end of the thawing.

### Model Validation

This section validates the first-principles model using the experimental data. To measure the temperature profile and interface position in each experiment, the thermal imaging camera was oriented to monitor the temperature from the top of the vial (FIG. 1). Some examples of the image data and relevant data analysis procedure are given in 18.

FIG. 8 compares the value of the interface position predicted by the first-principles model initialized by the measured temperatures and interface position at time t=0 with the measured interface position throughout the thawing. The prediction of the first-principles model deviates from the measured interface position by less than 0.05 (i.e., 5% of the vial radius) during the first 2 minutes but by more than 10% at later times when the interface position drops more rapidly. One cause of the deviation is that the first-principles model is based on heat transfer in one spatial dimension, but the actual thawing process occurs in three spatial dimensions. Another potential cause is that when most of the material is liquid, some movement of the frozen material could occur. Such movement can enhance convective heat transfer and induce asymmetric effects. This deviation can be improved by using a well-designed observer (Section 5.3).

### Observer Design

With the first-principles model established, the observer was designed following the procedure in Section 4.2. The observer has three gains: L₁, L₂, and L₃. Since the objective of cell thawing estimation is to track the interface position, this section first focuses on the design of the associated observer gain L₃. Then the section shows that values of the observer gains L₁ and L₂ do not significantly affect the interface tracking performance.

### Observer Gain Selection

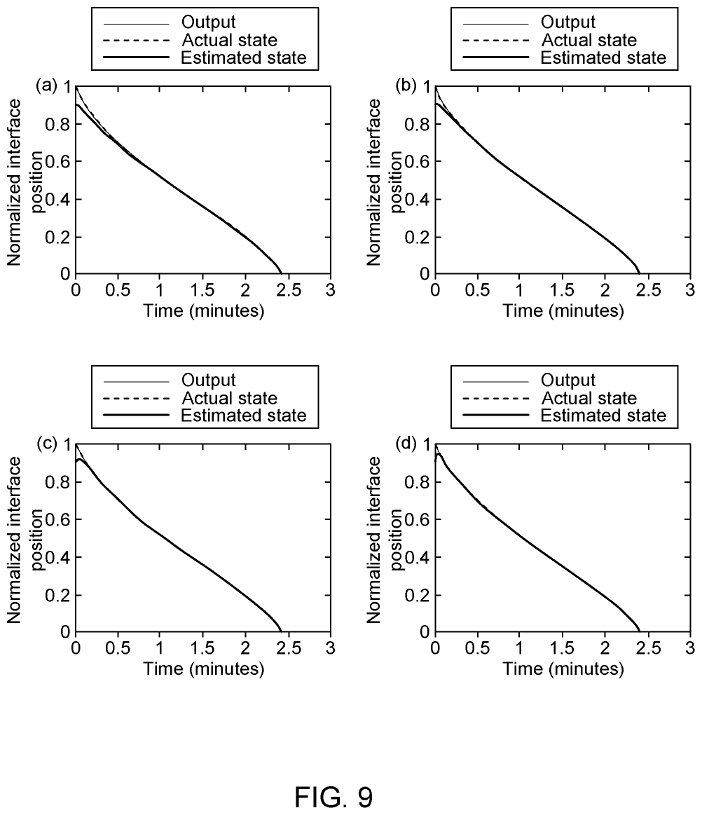

Noise-free model-based simulation results show that the proposed observer converges for a wide range of values of the observer gain L₃ for the solid-liquid interface (FIG. 9). The estimated interface position converges to the actual value in 30 seconds for values of the observer gain L₃ from −2 to −15, and slowly for L₃=−½.

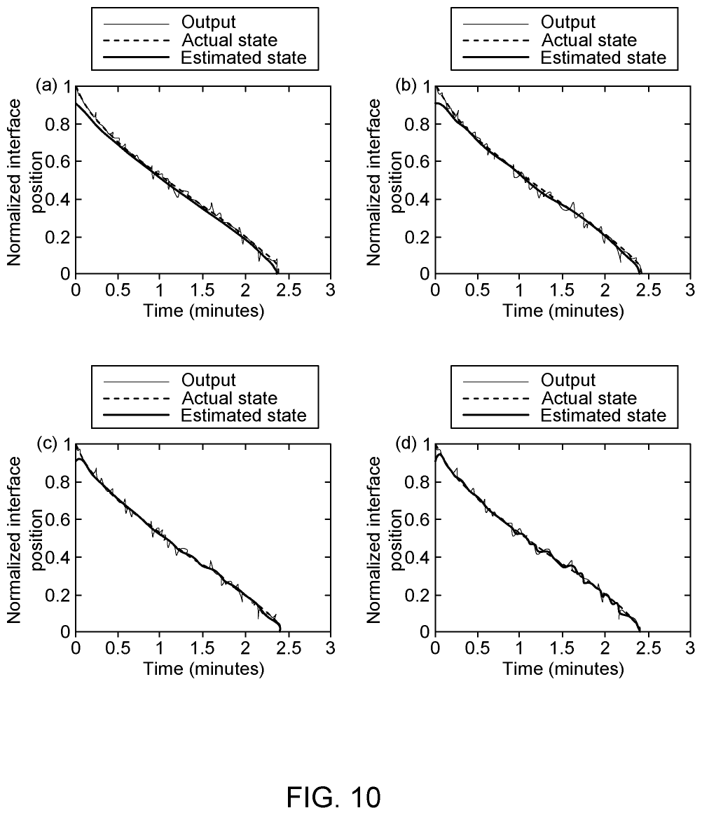

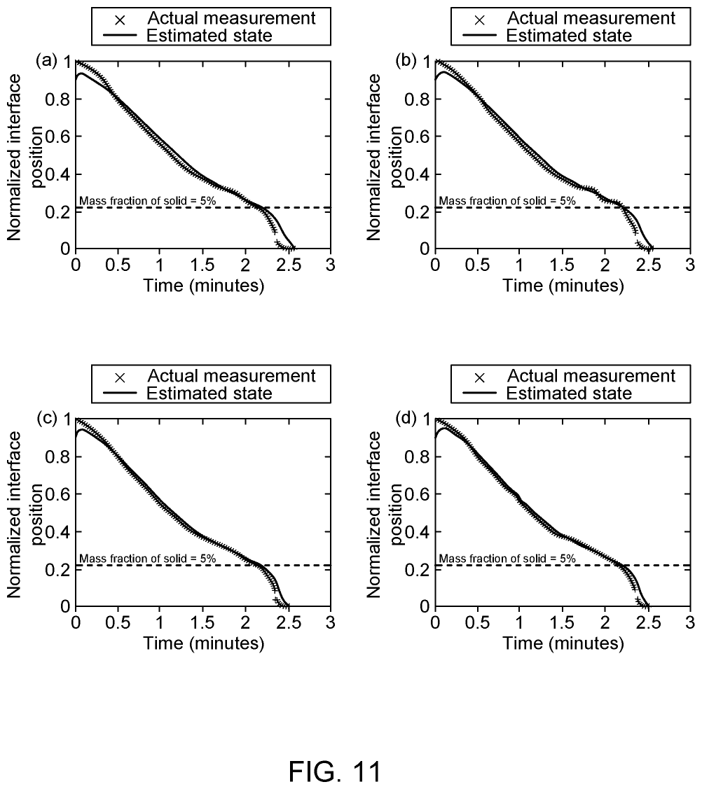

Model-based simulation results with normally distributed measurement noise show similarly fast convergence of the estimated interface position for values of the observer gain L₃ from 2 to 15 and poor convergence for L₃=½ (FIG. 10). For L₃=2, the estimated interface position is smooth and almost not polluted by noise (FIG. 10b). The estimate of the interface position is slightly noisy for L₃=5 but still provides a good estimate (FIG. 10c), implying that the gain should not be increased much further. When the observer gain is too high, the estimated interface position is noisy and does not give a good estimate of the state (FIG. 10d). These model-based results suggest that the optimal observer gain should be within the range of 2 to 5, with the final value decided by application to the experimental data.

When the observer is applied to experimental data, the estimated interface position reaches the measured value within 30 seconds for four values of the observer gain L₃ between 2 and 5 (FIG. 11). The observer poorly tracks the interface position between 0.5 to 1.5 minutes and after 2 minutes with the observer gain L₃=2 and 3 (FIG. 11ab), indicating the gain is too small. The convergence is improved for L₃ of 4 and 5, respectively (FIG. 11cd). For the observer gain L₃=5, the estimated interface position converges to the measured value throughout the process with slight deviation during the last few seconds where the interface drops rapidly (FIG. 11d). This small deviation is not a concern because it comes at the very end of the process after the mass fraction of the solid is 5% where the thawing process should be terminated. The interface position estimates have low sensitivity to measurement noise for all four values of the observer gain, with L₃=−5 having the fastest speed of convergence. As a result, all subsequent simulations use the observer gain L₃=−5.

The actual sensor noise in the experiment (FIG. 11) is not as strong as the sensor noise assumed based on the equipment specification of the thermal imaging camera (FIG. 10). The observer gain could be made larger in magnitude to improve convergence, but the observer would have higher sensitivity to noise. Since the observer converges efficiently with L₃=5, it is reasonable to use this gain to provide some margin for the observer to work well even with larger sensor noise, e.g., if some electronic equipment comes within the vicinity of the thermal imaging system.

### Comparison of Output Measurement Sets

The above derivations and results assume that all state measurements including the temperature profiles and interface position are available, which is valid for our thermal imaging camera setup. A drawback of such an estimator is that the temperature readings from thermal imaging can be inaccurate for low temperatures. For example, while the thermal imaging camera used in this work, FUR A35sc, can read the temperature down to 40° C. with an accuracy of 5° C. [33], the minimum temperature of our system is 80° C. Potential sensor bias motivates the design of an observer whose only measurement input is the inter-face position. In this case, the output matrices C₁ and C₂ in (51)-(54) are zero, and L₁ and L₂ are no longer design parameters of the observer.

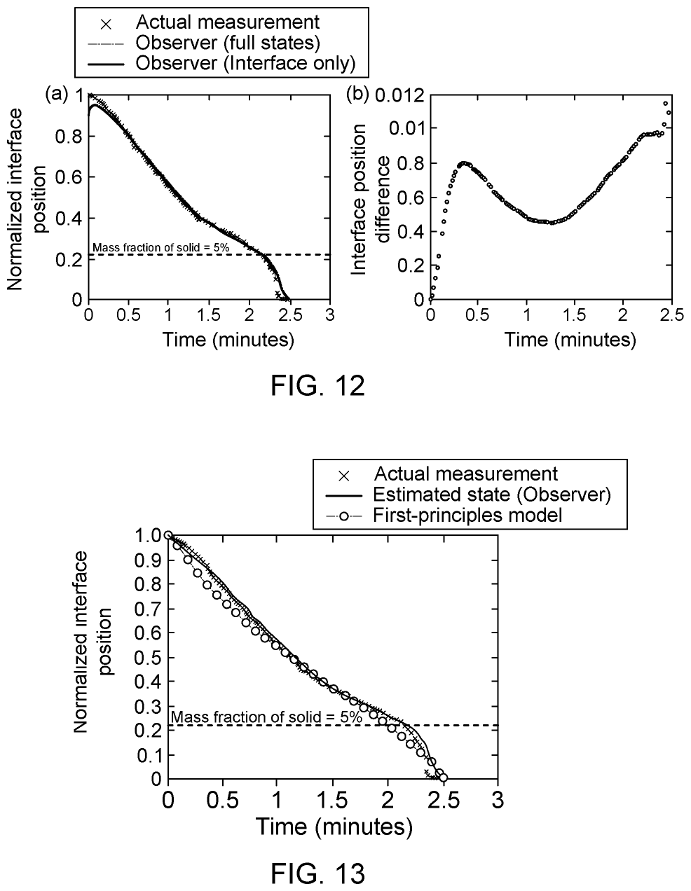

Dropping the temperature profile measurements from the observer only has a very small effect on the observer performance (FIG. 12). The estimated profiles are almost identical (FIG. 12a) with the difference in the estimated interface position of less than 0.01 (i.e., 1% of the vial radius) most of the time except for the end of the process where the error is slightly higher (FIG. 12b). These results indicate that the observer requires only the interface position measurement, which means only the observer gain L₃ is important in the observer design. Since the simplified observer does not receive any image data at low temperature values (much below the melting point), this observer is robust to such sensor bias.

### Real-Time State Estimation

The numerical model integrated with the observer was employed to perform real-time state estimation of the cell thawing process, focusing on tracking the moving solid-liquid interface and controlling the final mass fraction of the solid.

FIG. 13 compares the interface position predicted by the first-principles model and observer initialized by the measured temperatures and interface position at time t=0 with the measured interface position throughout the thawing. The measurement and prediction of the first-principles model are the same as those shown in FIG. 8, with the observer prediction added for comparison. As expected, the observer updating (50) corrects for the inevitable uncertainty in the first-principles model when determining the estimated interface position. The difference between the measured and estimated interface position is about 1-2% except for the last few seconds where the error slightly increases. In addition, the observer filters the noise in the measurement of the interface position.

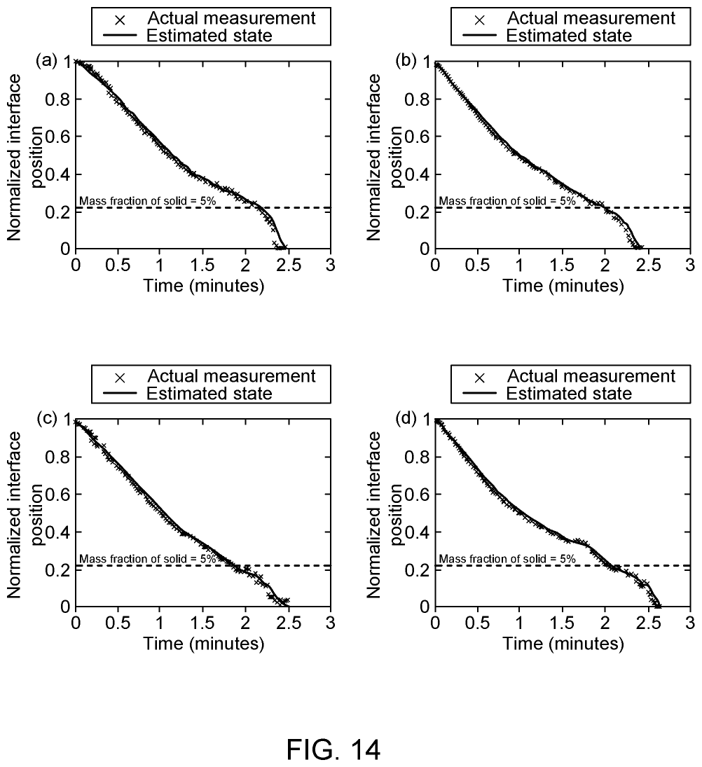

The observer was repeatedly tested under the given operating conditions (FIG. 14). In all cases, the observer accurately tracks the solid-liquid interface position through the end of the thawing process while filtering the measurement noise. The experimental performance over many runs provides confidence that the observer can be used to reliably control the cell thawing process.

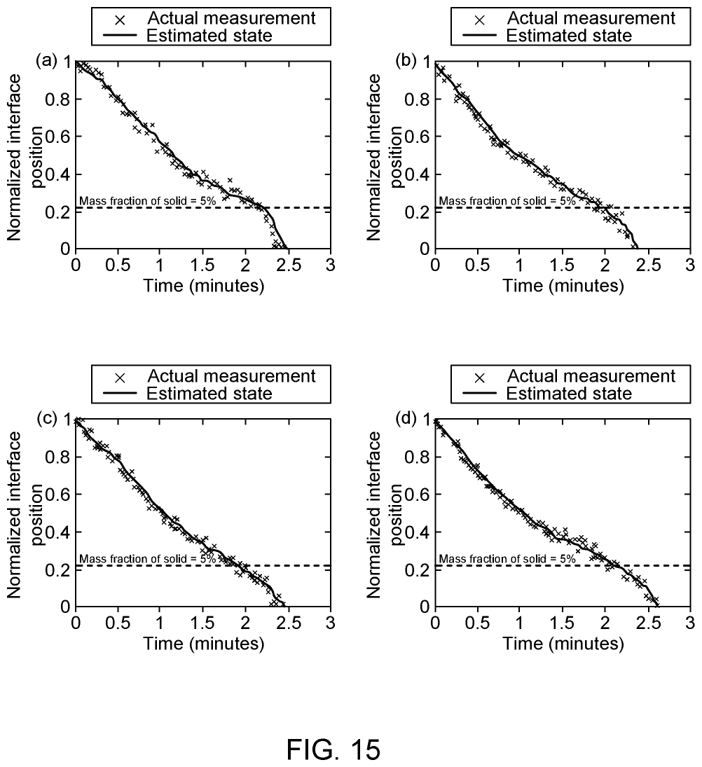

The observer design is also capable of handling a thermal imaging camera that has larger sensor noise. While some noise can be observed in the measured interface position (FIG. 14), the noise is relatively modest. The sensor noise can be larger, for example, when the spatial resolution of the thermal imaging camera is lower, or there is interference from electronic devices or other light sources. Our observer can give good interface position estimates even with very noisy data (FIG. 15). The observer has the most value for determining the endpoint of cell thawing when the thermal imaging data are noisy.

It is important to note that the numerical model and observer presented and tested in this work are based on thawing in one dimension. Nevertheless, in reality, frozen material is also heated from the bottom. As a result, vertical thawing can influence the final mass fraction of the frozen material.

### Conclusion

This work proposes a strategy for the dynamic simulation, state estimation, and control of the Stefan problems and applies the strategy to cell thawing. The first-principles model of cell thawing is derived from the one-dimensional, two-phase Stefan problem defined in the cylindrical coordinate system. A finite difference approximation is combined with the method of lines in a moving grid domain, which is a more accurate numerical scheme than typical fixed grid approaches and facilitates observer and control design. State estimation and control of the Stefan problem can be achieved by building the Luenberger observer upon the first-principles model with inputs from real-time thermal imaging of cells. With an optimal observer gain design, the observer corrects the states in the first-principles model while being insensitive to model uncertainty and measurement noise.

The numerical model and observer were employed in an experimental cell thawing process for real-time state estimation and control of the moving solid-liquid interface. The first-principles model simulates the evolution of the solid-liquid interface with errors of less than 5% when the solid phase dominates, and more than 10% when the system contains mostly liquid. The integrated model and observer can accurately predict the interface position within about 1-2% throughout the process in all experimental runs.

Some potential future directions would be to develop a model and design an observer for a system with more spatial dimensions, consider temperature-dependent properties, include convective heat transfer into the model, and explore advanced control systems design.

### Fixed Grid Dimensionalization

A common nondimensionalization technique for heat transfer problems in the radial direction is to define the normalized radius

$$R = \frac{\text{?}}{b} \text{?} \qquad ( A \text{.1} )$$

$$\text{?} \text{indicates text missing or illegible when filed}$$

where other variables and constants are the same as those defined in Section 2.4. As a result, the governing equations for the solid region (0<R<S) and liquid region (S<R<1) can be written as

$$\frac{\partial {θ}_{1}}{\partial \text{?}} = \frac{{\partial }^{2} {θ}_{1}}{\partial {R}^{2}} + \frac{1}{R} \frac{\partial {θ}_{1}}{\partial R} , \qquad ( A \text{.2} )$$

$$\frac{1}{\text{?}} \frac{\partial {θ}_{2}}{\partial \text{?}} = \frac{{\partial }^{2} {θ}_{2}}{\partial {R}^{2}} + \frac{1}{R} \frac{\partial {θ}_{2}}{\partial R} . \qquad ( A \text{.3} )$$

$$\text{?} \text{indicates text missing or illegible when filed}$$

The Robin boundary condition at R=1 is

$$\{ \begin{matrix}\frac{\partial {θ}_{1}}{\partial R} = {U}_{0} {k}_{0} ( 1 - {θ}_{1} ) & for τ \leq τ \text{?} \\ \frac{\partial {θ}_{2}}{\partial R} = {U}_{0} ( 1 - {θ}_{2} ) & for τ > τ \text{?}\end{matrix} \qquad ( A \text{.4} )$$

$$\text{?} \text{indicates text missing or illegible when filed}$$

For the symmetry condition at R=0,

$$\{ \begin{matrix}\frac{\partial {θ}_{1}}{\partial R} = 0 & for τ \leq η \text{?} \\ \frac{\partial {θ}_{2}}{\partial R} = 0 & for τ > η \text{?}\end{matrix} \qquad ( A \text{.5} )$$

$$\text{?} \text{indicates text missing or illegible when filed}$$

Finally, the Stefan conditions at R=S for τₛ<τ<τₗ include the melting point condition having the same form as (29), and the energy balance that becomes

$$\frac{1}{Ste} \frac{dS}{d \text{?}} = \frac{\partial {θ}_{1}}{\partial R} - {k}_{0} \frac{\partial {θ}_{2}}{\partial R} . \qquad ( A \text{.6} )$$

$$\text{?} \text{indicates text missing or illegible when filed}$$

Discretization of the above equations results in a fixed grid domain, i.e., the space between each grid point is constant and does not change with time. This approach is straightforward to implement numerically but requires adding or subtracting grid points in the two domains when the solid-liquid interface moves and tracking the time-varying distance between grid points near the interface.

### Numerical Methods for Fixed Grids

Applying the central difference (second order of accuracy) approximation to the spatially dependent terms and the forward Euler method to the time-dependent terms in (17) and (18) transforms the PDEs into the difference equations

$$\frac{{( {θ}_{1} )}_{i}^{k + 1} - {( {θ}_{1} )}_{i}^{k}}{Δ τ} = \frac{{( {θ}_{1} )}_{i}^{k + 1} - 2 {( {θ}_{1} )}_{i}^{k} + {( {θ}_{1} )}_{i - 1}^{k}}{{( Δ R )}^{2}} + \frac{{( {θ}_{1} )}_{i + 1}^{k} - {( {θ}_{1} )}_{i - 1}^{k}}{2 {i ( Δ R )}^{2}} , \qquad ( A \text{.7} )$$

$$\frac{{( {θ}_{2} )}_{i}^{k + 1} - {( {θ}_{2} )}_{i}^{k}}{\text{?} Δ τ} = \frac{{( {θ}_{2} )}_{i + 1}^{k} - 2 {( {θ}_{2} )}_{i}^{k} + {( {θ}_{2} )}_{i - 1}^{k}}{{( Δ R )}^{2}} + \frac{{( {θ}_{2} )}_{i + 1}^{k} - {( {θ}_{2} )}_{i - 1}^{k}}{2 {i ( Δ R )}^{2}} , ( A \text{.8} )$$

$$\text{?} \text{indicates text missing or illegible when filed}$$

where ΔR=1/n is the distance between adjacent grid points in the radial direction, i is the integer index in the radial direction (R=iΔR), Δτ is the time step, and k is the integer index along the time axis (r=kΔτ). The above difference equations can be solved iteratively by rearranging to give

Applying the central difference scheme to the Robin boundary condition results in

$$\{ \begin{matrix}\frac{( {θ}_{1} ) \text{?} - ( {θ}_{1} ) \text{?}}{2 Δ R} {U}_{0} {k}_{0} ( 1 - ( {θ}_{1} ) \text{?} ) & for τ \leq τ \text{?} \\ \frac{( {θ}_{2} ) \text{?} - ( {θ}_{2} ) \text{?}}{2 Δ R} {U}_{0} ( 1 - ( {θ}_{2} ) \text{?} ) & for τ > τ \text{?}\end{matrix} \qquad ( A \text{.11} )$$

$$\text{?} \text{indicates text missing or illegible when filed}$$

The symmetry condition at the center reformulated by L'Hôpital's rule is

$$\{ \begin{matrix}\frac{{( {θ}_{1} )}_{0}^{k + 1} - {( {θ}_{1} )}_{0}^{k}}{Δ τ} = \frac{4}{{( Δ R )}^{2}} ( ( {θ}_{1} ) \text{?} - {( {θ}_{1} )}_{0}^{k} ) & for τ \leq η \text{?} \\ \frac{{( {θ}_{2} )}_{0}^{k + 1} - {( {θ}_{2} )}_{0}^{k}}{Δ τ} = \frac{4 \text{?}}{{( Δ R )}^{2}} ( ( {θ}_{2} ) \text{?} - {( {θ}_{2} )}_{0}^{k} ) & for τ > η \text{?}\end{matrix} \qquad ( A \text{.12} )$$

$$\text{?} \text{indicates text missing or illegible when filed}$$

The Stefan conditions are

$${( {θ}_{1} )}_{p}^{k} = {( {θ}_{2} )}_{p}^{k} = 0 , \qquad ( A \text{.13} )$$

$$\frac{1}{Ste} ( \frac{{S}^{k + 1} - {S}^{k}}{Δ τ} ) = ( \frac{3 {( {θ}_{1} )}_{p}^{k}}{2 Δ R} - \frac{2 {( {θ}_{1} )}_{p - 1}^{k}}{Δ R} + \frac{{( {θ}_{1} )}_{p - 2}^{k}}{2 Δ R} ) - k \text{?} ( \frac{3 {( {θ}_{2} )}_{p}^{k}}{2 Δ R} - \frac{2 {( {θ}_{2} )}_{p + 1}^{k}}{Δ R} + \frac{{( {θ}_{2} )}_{p + 2}^{k}}{2 Δ R} ) \text{?} \qquad ( A \text{.14} )$$

$$\text{?} \text{indicates text missing or illegible when filed}$$

where S=pΔR varies between 0 and 1, and p is the position index of the moving interface (FIG. 16) rounded to the closest integer.

A drawback of solving the difference equations iteratively is that the time step Δτ is required to be small to ensure numerical stability, which is not computationally efficient. To avoid this issue, the PDEs can be alternatively handled by using the numerical method of lines (employed in the main paper), which discretizes the spatial derivatives only, converting each PDE into a system of ODEs. In this case, the discretized governing equations are

$$\frac{{d ( {θ}_{1} )}_{i}}{d \text{?}} = \frac{{( {θ}_{1} )}_{i + 1} - 2 {( {θ}_{1} )}_{i} + {( {θ}_{1} )}_{i - 1}}{{( Δ R )}^{2}} + \frac{{( {θ}_{1} )}_{i + 1} - {( {θ}_{1} )}_{i - 1}}{2 {i ( Δ R )}^{2}} , \qquad ( A \text{.15} )$$

$$\frac{1}{\text{?}} \frac{{d ( {θ}_{2} )}_{i}}{d \text{?}} = \frac{{( {θ}_{2} )}_{i + 1} - 2 {( {θ}_{2} )}_{i} + {( {θ}_{2} )}_{i - 1}}{{( Δ R )}^{2}} + \frac{{( {θ}_{2} )}_{i + 1} - {( {θ}_{2} )}_{i - 1}}{2 {i ( Δ R )}^{2}} . \qquad ( A \text{.16} )$$

$$\text{?} \text{indicates text missing or illegible when filed}$$

The Robin boundary condition is

$$\{ \begin{matrix}\frac{( {θ}_{1} ) \text{?} - ( {θ}_{1} ) \text{?}}{2 Δ R} {U}_{0} {k}_{0} ( 1 - ( {θ}_{1} ) \text{?} ) & for τ \leq τ \text{?} \\ \frac{( {θ}_{2} ) \text{?} - ( {θ}_{2} ) \text{?}}{2 Δ R} {U}_{0} ( 1 - ( {θ}_{2} ) \text{?} ) & for τ > τ \text{?}\end{matrix} \qquad ( A \text{.17} )$$

$$\text{?} \text{indicates text missing or illegible when filed}$$

The symmetry condition becomes

$$\{ \begin{matrix}\frac{{d ( {θ}_{1} )}_{0}}{d \text{?}} = \frac{4}{{( Δ R )}^{2}} ( {( {θ}_{1} )}_{1} - {( {θ}_{1} )}_{0} ) & for τ \leq η , \\ \frac{{d ( {θ}_{2} )}_{0}}{d \text{?}} = \frac{4 \text{?}}{{( Δ R )}^{2}} ( {( {θ}_{2} )}_{1} - {( {θ}_{2} )}_{0}^{k} ) & for τ > η .\end{matrix} \qquad ( A \text{.18} )$$

$$\text{?} \text{indicates text missing or illegible when filed}$$

The Stefan conditions are

$${( {θ}_{1} )}_{p} = {( {θ}_{2} )}_{p} = 0 , \qquad ( A \text{.19} )$$

$$\frac{1}{Ste} \frac{dS}{d \text{?}} = ( \frac{3 {( {θ}_{1} )}_{p}}{2 Δ R} - \frac{2 {( {θ}_{1} )}_{p - 1}}{Δ R} + \frac{{( {θ}_{1} )}_{p - 2}}{2 Δ R} ) - {k}_{0} ( - \frac{3 {( {θ}_{2} )}_{p}}{2 Δ R} - \frac{2 {( {θ}_{2} )}_{p + 1}}{Δ R} + \frac{{( {θ}_{2} )}_{p + 2}}{2 Δ R} ) . \qquad ( A \text{.20} )$$

$$\text{?} \text{indicates text missing or illegible when filed}$$

In comparison with the technique above, this approach is easier to implement as the discretization is straightforward, and the PDEs/ODEs are linear. Nevertheless, there are significant disadvantages. FIGS. 16 and 17 pictorially illustrate the discretization of the fixed grid domain and evolution of the moving interface, respectively. The indices are i=0 at the center to i=n at the outer boundary. The interface position is labeled with the index p. With this approach, the space between each grid is always constant, i.e., does not change with time. In addition, the total number of grid points is fixed at n+1. The number of grid points in each phase, however, varies as the moving interface moves, i.e., as the index p changes.

As such, the number of grids in each region changes with time. In terms of numerical solutions, this change can cause some issues at the beginning of thawing because the number of grid points in the liquid phase is low during this time. For example, when p=n 1, there is only one grid point in the liquid region and having only one grid point to capture a high temperature gradient in the liquid phase results in an inaccurate solution. The same issue can occur when thawing almost completes, i.e., the solid region is small. Another problem of this approach is that variation in the number of grid points implies that the number of states in each region is not constant, which is not preferable in state estimation and process control. These issues can be avoided by using the moving grid technique proposed below.

### Thermal Imaging Data Analysis

The spatial temperature fields recorded by the thermal imaging camera indicate radial symmetry during thawing (FIG. 18). The temperature map was interpolated linearly between pixels to obtain the temperature corresponding to each grid point for the numerical model.

The radial position of the solid-liquid interface from the measurement (y₃) can be determined by

$$\text{?} = \sqrt{\frac{{A}_{s}}{{A}_{t}}} \text{?} \qquad ( A . 21 )$$

$$\text{?} \text{indicates text missing or illegible when filed}$$

where Aₛ is the circle area covering the solid phase, i.e., the region with temperatures lower than the melting point of −2° C., and Aₜ is the total circle area of the cell vial. By connecting the camera to MATLAB, the temperature profile and interface position were extracted from each spatial temperature field and recorded every second.

### Vertical Thawing Correction

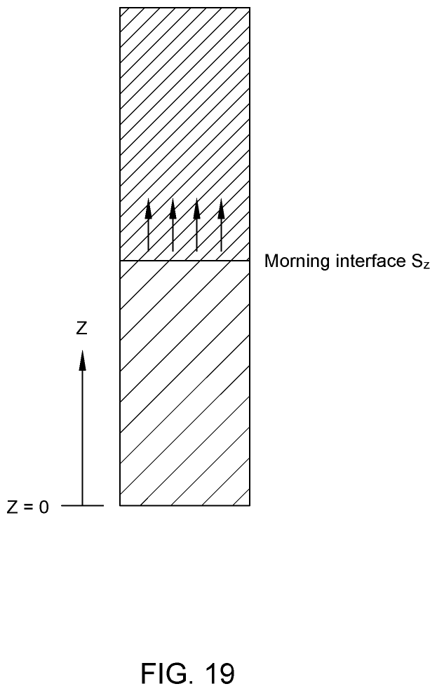

Although the observer design presented in this work is based on thawing in one dimension (r), thawing in the vertical direction (z) at the bottom of the frozen material would affect the mass fraction of the solid (FIG. 19). This section estimates the error caused by neglecting vertical thawing.

If the bottom of the vial has curvature similar to its sides, then the thickness of liquid at the bottom of the vial will be nearly the same as the thickness of liquid on the sides [47], and this can be used to correct the fraction of frozen material. For example, for frozen material of height of 43 mm in a vial of radius 5 mm, the height of 43 mm would be corrected to 43−4=39 mm when the frozen material has a radius of 1 mm. This correction to the mass of frozen material would be (43−39)/43=9.3%.

For a vial bottom that is flat, a somewhat more involved analysis results in a similar estimate for the thickness of liquid at the bottom of the vial. As explained and derived in [1], the motion of the solid-liquid interface in the vertical direction can be approximated using a similarity solution. (The similarity solution assumes that there is no heat transfer resistance between the vial and the material inside the vial, and the temperature gradient in the solid is negligible. As such, the analysis is slightly conservative.) The interface position in the vertical direction (s_{z}) is given by

$$\text{?} = λ \sqrt{4 \text{?}} , \qquad ( A . 22 )$$

$$\text{?} \text{indicates text missing or illegible when filed}$$

where λ is a constant that satisfies the relation

$$λ \text{?} erf λ = \frac{C \text{?} ( {T}_{0} - {T}_{m} )}{Δ {H}_{f} \sqrt{π}} . \qquad ( A . 23 )$$

$$\text{?} \text{indicates text missing or illegible when filed}$$

From the results shown above, the time scale of thawing is around 2.5 minutes. With this time scale, the vertical interface position s_{z} is about 4 mm, which should be considered in comparison to the height of our vial of about 43 mm. Hence, the error when neglecting vertical thawing is about 10% in the solid mass fraction. This error is not negligible but also not significant enough to prevent the one-dimensional model from working reliably. This small correction can be simply added to the current model to obtain a more accurate prediction of the solid fraction of frozen material.

TABLE 1
Default parameters in the simulations

| Parameter | Value | Unit | Description |
|---|---|---|---|
| ρ₁ | 916 | kg/m [symbol] | Density of the solid |
| ρ₂ | 1000 | kg/m [symbol] | Density of the liquid |
| k₁ | 2.22 | W/(mK) | Thermal conductivity of the solid |
| k₂ | 0.556 | W/(mK) | Thermal conductivity of the liquid |
| C [symbol] ₁ | 2.050 | kJ/(kg ° C.) | Heat capacity of the solid |
| C [symbol] ₂ | 4.204 | kJ/(kg ° C.) | Heat capacity of the liquid |
| ΔH [symbol] | 334 | kJ/kg | Latent heat of fusion |
| U | 850 | W/(m²K) | Overall heat transfer coefficient |
| b | 5 | mm | Vial radius |
| To | 37 | ° C. | Heater temperature |
| Tm | −2 | ° C. | Melting point |
| n | 50 | — | Number of grid points |

[symbol]

indicates data missing or illegible when filed

### BIBLIOGRAPHY

[1]H. Carslaw, J. Jaeger, Conduction of Heat in Solids, 2nd Edition, Oxford University.
[2]R. B. Bird, E. N. Lightfoot, W. E. Stewart, Transport Phenomena, 2nd Edition, John Wiley & Sons, New York, 2002.
[3]A. Friedman, D. Kinderlehrer, A one phase Stefan problem, Indiana University Mathematics Journal 24 (11) (1975) 1005-1035. URL http://www.jstor.org/stable/24890912
[4]G. H. Meyer, A numerical method for two-phase Stefan problems, SIAM Journal on Numerical Analysis 8 (3) (1971) 555-568. URL http://www.jstor.org/stable/2949674
[5]A. Kar, J. Mazumder, Analytical solution of the Stefan problem in finite mediums, Quarterly of Applied Mathematics 52 (1) (1994) 49-58. URL https://www.jstor.org/stable/43637971
[6]L. N. Tao, The Stefan problem of a polymorphous material, Journal of Applied Me-chanics 46 (4) (1979) 789-794.URL https://doi.org/10.1115/1.3424655
[7]F. Brosa Planella, C. P. Please, R. A. Van Gorder, Extended Stefan problem for solidification of binary alloys in a finite planar domain, SIAM Journal on Applied Mathematics 79 (3) (2019) 876-913. URL https://doi.org/10.1137/18M118699X
[8]F. Brosa Planella, C. P. Please, R. A. Van Gorder, Extended Stefan problem for the solidification of binary alloys in a sphere, European Journal of Applied Mathematics 32 (2) (2021) 242-279. URL https://doi.org/10.1017/S095679252000011X
[9]V. V. Mikova, G. I. Kurbatova, N. N. Ermolaeva, Analytical and numerical solutions to Stefan problem in model of the glaciation dynamics of the multilayer cylinder in sea water, Journal of Physics: Conference Series 929 (2017) 012103. URL https://doi.org/10.1088/1742-6596/929/1/012103
[10]M. Brezina, L. Klimes, J. Stetina, Optimization of material properties of phase change materials for latent heat thermal energy storage, MENDEL 24 (1) (2018) 47-54. URL https://doi.org/10.13164/mendel.2018.1.047
[11]B. Rubinsky, A. Shitzer, Analysis of a Stefan-like problem in a biological tissue around a cryosurgical probe, Journal of Heat Transfer 98 (3) (1976) 514-519. URL https://doi.org/10.1115/1.3450587
[12]Y. Rabin, A. Shitzer, Exact solution to the one-dimensional inverse-Stefan problem in nonideal biological tissues, Journal of Heat Transfer 117 (2) (1995) 425-431. URL https://doi.org/10.1115/1.2822539
[13]Y. Rabin, A. Shitzer, Combined solution of the inverse Stefan problem for successive freezing/thawing in nonideal biological tissues, Journal of Biomechanical Engineering 119 (2) (1997) 146-152. URL https://doi.org/10.1115/1.2796073
[14]M. P. Dalwadi, S. L. Waters, H. M. Byrne, I. J. Hewitt, A mathematical framework for developing freezing protocols in the cryopreservation of cells, SIAM Journal on Applied Mathematics 80 (2) (2020) 657-689. URL https://doi.org/10.1137/19M1275875
[15]J. Bollati, D. A. Tarzia, One-phase Stefan-like problems with latent heat depending on the position and velocity of the free boundary and with Neumann or Robin bound-ary conditions at the fixed face, Mathematical Problems in Engineering 2018 (2018) 4960391. URL https://doi.org/10.1155/2018/4960391
[16]D. McCord, J. Crepeau, A. Siahpush, J. A. Ferres Brogin, Analytical solutions to the Stefan problem with internal heat generation, Applied Thermal Engineering 103 (2016) 443-451. URL https://doi.org/10.1016/j.applthermaleng.2016.03.122
[17]M. Z. Khalid, M. Zubair, M. Ali, An analytical method for the solution of two phase Stefan problem in cylindrical geometry, Applied Mathematics and Computation 342 (2019) 295-308. URL https://doi.org/10.1016/j.amc.2017.09.013
[18]F. Sartoretto, R. Spigler, Numerical solution for the one-phase Stefan problem by piece-wise constant approximation of the interface, Computing 45 (1990) 235-249. URL https://doi.org/10.1007/BF02250635
[19]S. Kutluay, A. R. Bahadir, A. Özdeş, The numerical solution of one-phase classical Stefan problem, Journal of Computational and Applied Mathematics 81 (1) (1997) 135-144. URL https://doi.org/10.1016/S0377-0427(97)00034-4
[20]N. Popov, S. Tabakova, F. Feuillebois, Numerical modelling of the one-phase Stefan problem by finite volume method, in: Z. L₁, L. Vulkov, J. Wasniewski (Eds.), Numer-ical Analysis and Its Applications, Vol. 3401, Springer, Berlin, Heidelberg, 2005, pp. 456-462. URL https://doi.org/10.1007/978-3-540-31852-1_55
[21]S. Savović, J. Caldwell, Numerical solution of Stefan problem with time-dependent boundary conditions by variable space grid method, Thermal Science 13 (4) (2009) 165-174. URL https://doi.org/10.2298/TSCI0904165S
[22]S. Mitchell, M. Vynnycky, On the numerical solution of two-phase Stefan problems with heat-flux boundary conditions, Journal of Computational and Applied Mathematics 264 (2014) 49-64. URL https://doi.org/10.1016/j.cam.2014.01.003
[23]H. Karabenli, A. Esen, E. Aksan, Numerical solutions for a Stefan problem, New Trends in Mathematical Science 4 (4) (2016) 175-187. URL https://doi.org/10.20852/ntmsci.2016422668
[24]G. I. Kurbatova, N. N. Ermolaeva, An effective algorithm of the numerical solution to the Stefan problem, Journal of Physics: Conference Series 1392 (2019) 012034. URL https://doi.org/10.1088/1742-6596/1392/1/012034
[25]A. O. Gusev, O. V. Shcheritsa, O. S. Mazhorova, Two equivalent finite volume schemes for Stefan problem on boundary-fitted grids: Front-tracking and front-fixing techniques, Differential Equations 57 (7) (2021) 876-890. URL https://doi.org/10.1134/S0012266121070053
[26]S. Koga, M. Diagne, M. Krstic, Control and state estimation of the one-phase Ste-fan problem via backstepping design, IEEE Transactions on Automatic Control 64 (2) (2019) 510-525. URL https://doi.org/10.1109/TAC.2018.2836018
[27]B. Petrus, J. Bentsman, B. G. Thomas, Feedback control of the two-phase Stefan problem, with an application to the continuous casting of steel, in: 49th IEEE Conference on Decision and Control, 2010, pp. 1731-1736. URL https://doi.org/10.1109/CDC.2010.5717456
[28]U. G. Abdulla, B. Poggi, Optimal control of the multiphase Stefan problem, Applied Mathematics & Optimization 80 (2019) 479-513. URL https://doi.org/10.1007/s00245-017-9472-7
[29]J. Baboo, P. Kilbride, M. Delahaye, S. Milne, F. Fonseca, M. Blanco, J. Meneghel, A. Nancekievill, N. Gaddum, G. J. Morris, The impact of varying cooling and thawing rates on the quality of cryopreserved human peripheral blood T cells, Scientific Reports 9 (2019) 3417. URL https://doi.org/10.1038/s41598-019-39957-x
[30]C. J. Hunt, Technical considerations in the freezing, low-temperature storage and thawing of stem cells for cellular therapies, Transfusion Medicine and Hemotherapy 46 (3) (2019) 134-149. URL https://doi.org/10.1159/000497289
[31]M. Uhrig, F. Ezquer, M. Ezquer, Improving cell recovery: Freezing and thawing optimization of induced pluripotent stem cells, Cells 11 (5) (2022) 799. URL https://doi.org/10.3390/cells11050799
[32]C. Cottle, A. P. Porter, A. Lipat, C. Turner-Lyles, J. Nguyen, G. Moll, R. Chinnadurai, Impact of cryopreservation and freeze-thawing on therapeutic properties of mesenchymal stromal/stem cells and other common cellular therapeutics, Current Stem Cell Reports 8 (2) (2022) 72-92. URL https://doi.org/10.1007/s40778-022-00212-1
[33] FLIR, User's manual FLIR Ax5 series, FLIR Systems, Portland (2018).
[34]Y. Hayashi, M. Kino-oka, H. Sugiyama, Hybrid-model-based design of fill-freeze-thaw processes for human induced pluripotent stem cells considering productivity and quality, Computers & Chemical Engineering 156 (2022) 107566. URL https://doi.org/10.1016/j.compchemeng.2021.107566
[35]B. Šarler, Stefan's work on solid-liquid phase changes, Engineering Analysis with Boundary Elements 16 (2) (1995) 83-92. URL https://doi.org/10.1016/0955-7997(95)00047-X
[36]A. Mesbah, A. N. Ford Versypt, X. Zhu, R. D. Braatz, Nonlinear model-based control of thin-film drying for continuous pharmaceutical manufacturing, Industrial & Engineering Chemistry Research 53 (2014) 7447-7460. URL https://doi.org/10.1021/ie402837c
[37]W. Schiesser, The Numerical Method of Lines: Integration of Partial Differential Equations, Academic Press, San Diego, 1991.
[38]J. Crank, The Mathematics of Diffusion, 2nd Edition, Oxford University Press, London, 1975.
[39]A. N. Ford Versypt, R. D. Braatz, Analysis of finite difference discretization schemes for diffusion in spheres with variable diffusivity, Computers & Chemical Engineering 71 (2014) 241-252. URL https://doi.org/10.1016/j.compchemeng.2014.05.022
[40]D. Luenberger, An introduction to observers, IEEE Transactions on Automatic Control 16 (6) (1971) 596-602. URL 10.1109/TAC.1971.1099826
[41]W. Wang, Z. Gao, A comparison study of advanced state observer design techniques, in: Proceedings of the American Control Conference, Vol. 6, 2003, pp. 4754-4759. URL https://doi.org/10.1109/ACC.2003.1242474
[42]E. V. Kumar, J. Jerome, S. Ayyappan, Comparison of four state observer design algo-rithms for mimo system, Archives of Control Sciences 23 (2013) 243-256. URL https://doi.org/10.2478/acsc-2013-0015
[43]H. Jang, J. H. Lee, R. D. Braatz, K.-K. K. Kim, Fast moving horizon estimation for a two-dimensional distributed parameter system, Computers & Chemical Engineering 63 (2014) 159-172. URL https://doi.org/10.1016/j.compchemeng.2013.12.005
[44]R. Tarantino, F. Szigeti, E. Colina-Morles, Generalized Luenberger observer-based fault-detection filter design: an industrial application, Control Engineering Practice 8 (2000) 665-671. URL https://doi.org/10.1016/S0967-0661(99)00181-1
[45]D. Vries, K. J. Keesman, H. Zwart, A Luenberger observer for an infinite dimensional bilinear systems: A UV disinfection example, IFAC Proceedings Volumes 40 (20) (2007) 667-672. URL https://doi.org/10.3182/20071017-3-BR-2923.00109
[46]J. Mohd Ali, N. Ha Hoang, M. A. Hussain, D. Dochain, Review and classification of recent observers applied in chemical process systems, Computers & Chemical Engineer-ing 76 (2015) 27-41. URL https://doi.org/10.1016/j.compchemeng.2015.01.019
[47]W. Deen, Analysis of Transport Phenomena, Oxford University Press, New York, 1998.

### Exemplary Systems and Methods

In various embodiments, a “variable profile” refers to a functional relationship between two or more variables (e.g., temperature, spatial variables, time, or other suitable variables). This functional relationship can be expressed as a plot. For example, a variable profile can be a temperature profile showing the relationship between temperature and a spatial variable representing a position of the boundary between one phase and another phase. In various embodiments, a spatial variable represents a position in (x, y) coordinates. In various embodiments, a spatial variable represents a radial position.

In various embodiments, a control system is configured based on a termination condition. In various embodiments, the termination condition is determined by the ratio of the mass or the volume of one phase to another phase of the sample. In various embodiments, the termination condition is determined by the ratio of the mass or the volume of one phase to another phase of the sample ranging from about 0.1% to about 25%. In various embodiments, the termination condition is met when the ratio of the mass or the volume of one phase to another phase of the sample is about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%. In various embodiments, the termination condition is met when the ratio of the mass or the volume of one phase to another phase of the sample is about 5%. In various embodiments, the termination condition is met when the ratio of the mass or the volume of the solid phase to liquid phase of the sample is less than or equal to about 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, or 25%.

In various embodiments, the methods and devices disclosed herein optionally include pre-processing data, such as images. Such optional pre-processing can generate data that is then inputted into a state estimator module, as described in details herein.

The pre-processing can comprise estimating an approximate location of the phase boundary and/or extracting at least one variable profile.

In general, pre-processing procedures employed by the methods and devices may include averaging data (e.g., averaging two or more images).

In various embodiments, averaging can include arithmetic averaging of images, i.e. computing an arithmetic average of values of pixels over two or more images. For example, for a plurality of images or frames obtained (e.g., by a camera) over a time interval (e.g., per second or other suitable time scale), where each image comprises temperature data, averaging includes taking an arithmetic average of specific temperature data corresponding to at least some pixels of any two or more frames of the plurality of frames. In various embodiments, all pixels of the images are averaged.

In alternative embodiments, averaging refers to taking a weighted average of values of a specific variable corresponding to the data (e.g., an image), also knowns as “filtering” as further explained below.

In this disclosure, a “filter” refers to is a device or process that removes some unwanted components or features from a signal. In various embodiments of the present disclosure, the filter The techniques of filtering in signal processing can be applied to processing images. Such techniques can be useful compared to taking an unweighted average (or arithmetic average) when the time scale of the processing of images is close to the time scale of the imaging.

In various embodiments, the present disclosure, as described herein, includes a first-order filter (e.g., exponentially weighted moving average filter) or filtering method. In various embodiments, the present disclosure, as described herein, includes a low-pass filter or filtering method.

In general, filtering uses different weights for recent images compared to past images. An example filtering is low-pass filtering. A version of the equation is:

Image_filtered=(alpha)(Image_filtered)+(1−alpha)(Image_measured)
where alpha is a scalar between 0 and 1 which defines how much filtering is used. Filters can be continuous or discrete time; can be high, low, notch, or band-pass (or more); and can be low, medium, or high order.

In signal processing, a filter is a device or process that removes some unwanted components or features from a signal. The techniques of filtering in signal processing can be applied to processing images. Such techniques can be useful compared to taking an unweighted average when the time scale of the processing of images is not much slower than the time scale of the imaging.

In various embodiments, the frames (images) selected for averaging are frames taken over a time interval (“time window”) that is shorter than a characteristic time scale of the phase transition. For example, if the phase transition has a time scale of minutes, then a time interval between the at least two frames selected for averaging is less than about one minute.

In various embodiments, image acquisition is accomplished using a video camera having a frame rate. The frames selected for averaging can be any two or more frames taken during a given time interval. For example, if the frame rate is 60 frames per second (fps), then in various embodiments all 60 frames taken during a 1-second time interval can be averaged, or the 1^{st} and the 60^{th} frames taken during a 1-second interval, or each 10^{th} frame out of the 60 frames can be averaged. Alternatively, one frame (e.g. a 1^{st}) frame of a first 1-second interval can be averaged with the another frame (e.g. a 1^{st}) of a second 1-second interval. A person of ordinary skill in the art would understand that any selection of two or more frames acquired over any one or more time intervals can be averaged.

In various embodiments, a heat transfer device as described herein includes a cold plate, a heating lamp, a hot air blower, a water bath, a bead bath, and/or other suitable devices. In various embodiments, a heat transfer device as described herein includes a cold plate, available from QInstruments, Germany. In various embodiments, the heat transfer device provides a temperature range from about −20.0° C. to about 99.9° C. In various embodiments, the heat transfer device provides a temperature range from about 0.0° C. to about 90.0° C. In various embodiments, the heat transfer device is configured to control heating and/or cooling at a pre-determined temperature.

In various embodiments, an image acquisition module as described herein includes an infrared camera, a visible camera, and/or a multispectral camera. In various embodiments, an image acquisition module includes a FUR A35sc Benchtop Test Kit, available from TEquipment.net, NJ.

In various embodiments, the devices, systems, and/or methods as described herein includes a design technique for a state estimator such as a Luenberger observer. In various embodiments, such observer design technique is configured to separate the states of a sample in three regions: (1) solid, (2) liquid, and (3) interface. In various embodiments, one or each of the states of the sample depends on a different set of parameters and/or measurement data.

Accordingly, in a first example embodiment, the present invention is a device. In a 1^{st} aspect of the 1^{st} example embodiment, the device comprises: a heat transfer device, adapted to be thermally connected with a sample, the sample having a first phase and a second phase, with the sample being initially in the first phase, an image acquisition module adapted to acquire an image of the sample, and a control system operably connected to the heat transfer device and the image acquisition module, wherein the control system is configured to, while a termination condition is not met: cause heat transfer between the heat transfer device and the sample, thereby causing a phase transition of the sample from the first phase to the second phase; cause the acquisition module to acquire the image of the sample, based on the image of the sample, determine the position of a boundary between the first phase and the second phase of the sample; and based on the determined position of the boundary, determine whether the termination condition is met.

In a 2^{nd} aspect of the 1^{st} example embodiment, the first phase is solid and the second phase is liquid. The remainder of features and example features of the device are as described above with respect to the 1^{st} aspect.

In a 3^{rd} aspect of the 1^{st} example embodiment, the sample comprises cells. The remainder of features and example features of the device are as described above with respect to the 1^{st} and 2^{nd} aspects.

In a 4^{th} aspect of the 1^{st} example embodiment, the termination condition is determined by the amount of the first phase and/or the second phase of the sample. The remainder of features and example features of the device are as described above with respect to the 1^{st} through 3^{rd} aspects.

In a 5^{th} aspect of the 1^{st} example embodiment, the termination condition is determined by the ratio of the mass or the volume of the first phase to the second phase of the sample. The remainder of features and example features of the device are as described above with respect to the 1^{st} through 4^{th} aspects.

In a 6^{th} aspect of the 1^{st} example embodiment, the mass or volume of the first phase is about 5% of the sample. The remainder of features and example features of the device are as described above with respect to the 1^{st} through 5^{th} aspects.

In a 7^{th} aspect of the 1^{st} example embodiment, the image of the sample is an IR image, a visible range image, or a multispectral image. The remainder of features and example features of the device are as described above with respect to the 1^{st} through 6^{th} aspects.

In an 8^{th} aspect of the 1^{st} example embodiment, the control system further comprises a state estimator module configured to determine the position of a boundary between the first phase and the second phase of the sample. The remainder of features and example features of the device are as described above with respect to the 1^{st} through 7^{th} aspects.

In a 9^{th} aspect of the 1^{st} example embodiment, the state estimator module comprises a Luenberger observer. The remainder of features and example features of the device are as described above with respect to the 1^{st} through 8^{th} aspects.

In a 10^{th} aspect of the 1^{st} example embodiment, the image acquisition module is configured to acquire a plurality of images. The remainder of features and example features of the device are as described above with respect to the 1^{st} through 9^{th} aspects.

In a 11^{th} aspect of the 1^{st} example embodiment, the control system further comprises a pre-processing module configured to pre-process at least two of the plurality of the acquired images, and, based on the at least two of the acquired images, determine an approximated position of the boundary between the first phase and the second phase of the sample. The remainder of features and example features of the device are as described above with respect to the 1^{st} through 10^{th} aspects.

In an 12^{th} aspect of the 1^{st} example embodiment, the pre-processing module is further configured to determine, based on at least one of the plurality of the acquired images, at least one variable profile. The remainder of features and example features of the device are as described above with respect to the 1^{st} through 10^{th} aspects.

In a 13^{th} aspect of the 1^{st} example embodiment, the pre-processing module is operably connected to the state estimator module, and wherein the state estimator module is configured to determine the position of the boundary between the first phase and the second phase of the sample based on the approximated position of the boundary, and, optionally, based on the at least one variable profile. The remainder of features and example features of the device are as described above with respect to the 1^{st} through 11^{th} aspects.

In a 14^{th} aspect of the 1^{st} example embodiment, the at least one variable is temperature. The remainder of features and example features of the device are as described above with respect to the 12^{th} aspect.

In a second example embodiment, the present disclosure is a method for controlling a phase transition of a sample. In a 1^{st} aspect of the 2^{nd} example embodiment, the method comprises: thermally connecting a sample with a heat transfer device, the sample having a first phase and a second phase, with the sample being initially in the first phase; operating a control system while a termination condition is not met, the control system being operably connected to the heat transfer device and an image acquisition module, wherein operating the control module comprises: causing heat transfer between the heat transfer device and the sample, thereby causing a phase transition from the first phase to the second phase; causing the image acquisition module to acquire an image of the sample; based on the image of the sample, determining the position of a boundary between the first phase and the second phase of the sample; based on the determined position of the boundary, determining whether the termination condition is met.

In a 2^{nd} aspect of the 2^{nd} example embodiment, the first phase is solid and the second phase is liquid. The remainder of features and example features of the method are as described above with respect to the 1^{st} aspect.

In a 3^{rd} aspect of the 2^{nd} example embodiment, the sample comprises cells. The remainder of features and example features of the method are as described above with respect to the 1^{st} and 2^{nd} aspects.

In a 4^{th} aspect of the 2^{nd} example embodiment, the termination condition is determined by the amount of the first phase and/or the second phase of the sample. The remainder of features and example features of the method are as described above with respect to the 1^{st} through 3^{rd} aspects.

In a 5^{th} aspect of the 2^{nd} example embodiment, the termination condition is determined by the ratio of the mass or the volume of the first phase to the second phase of the sample. The remainder of features and example features of the method are as described above with respect to the 1^{st} through 4^{th} aspects.

In a 6^{th} aspect of the 2^{nd} example embodiment, the mass or volume of the first phase is about 5% of the sample. The remainder of features and example features of the method are as described above with respect to the 1^{st} through 5^{th} aspects.

In a 7^{th} aspect of the 2^{nd} example embodiment, the image of the sample is an IR image, a visible range image, or a multispectral image. The remainder of features and example features of the method are as described above with respect to the 1^{st} through 6^{th} aspects.

In an 8^{th} aspect of the 2^{nd} example embodiment, the control system further comprises a state estimator module configured to determine the position of a boundary between the first phase and the second phase of the sample. The remainder of features and example features of the method are as described above with respect to the 1^{st} through 7^{th} aspects.

In a 9^{th} aspect of the 2^{nd} example embodiment, the state estimator module comprises a Luenberger observer. The remainder of features and example features of the method are as described above with respect to the 1^{st} through 8^{th} aspects.

In a 10^{th} aspect of the 2^{nd} example embodiment, the image acquisition module is configured to acquire a plurality of images. The remainder of features and example features of the method are as described above with respect to the 1^{st} through 9^{th} aspects.

In an 11^{th} aspect of the 2^{nd} example embodiment, the control system further comprises a pre-processing module configured to pre-process at least two of the plurality of the acquired images, and, based on the at least two of the acquired images, determine an approximated position of the boundary between the first phase and the second phase of the sample. The remainder of features and example features of the method are as described above with respect to the 1^{st} through 10^{th} aspects.

In a 12^{th} aspect of the 2^{nd} example embodiment, the pre-processing module is further configured to determine, based on at least one of the plurality of the acquired images, at least one variable profile. The remainder of features and example features of the method are as described above with respect to the 1^{st} through 11^{th} aspects.

In a 13^{th} aspect of the 2^{nd} example embodiment, the pre-processing module is operably connected to the state estimator module, and wherein the state estimator module is configured to determine the position of the boundary between the first phase and the second phase of the sample based on the approximated position of the boundary, and, optionally, based on the at least one variable profile. The remainder of features and example features of the method are as described above with respect to the 1^{st} through 12^{th} aspects.

In a 14^{th} aspect of the 2^{nd} example embodiment, operating the control system further comprises causing the pre-processing module to determine, based on at least one of the acquired images, at least one variable profile. The remainder of features and example features of the method are as described above with respect to the 1^{st} through 13^{th} aspects.

In a 15^{th} aspect of the 2^{nd} example embodiment, operating the control system comprises causing the state estimator module to determine the position of the boundary between the first phase and the second phase of the sample based on the approximated position of the boundary, and, optionally, based on the at least one variable profile. The remainder of features and example features of the method are as described above with respect to the 1^{st} through 14^{th} aspects.

In a 16^{th} aspect of the 2^{nd} example embodiment, the at least one variable is temperature. The remainder of features and example features of the method are as described above with respect to the 14^{th} aspect.

In a 3^{rd} example embodiment, the present disclosure is a non-transitory computer-readable medium having stored thereon computer-readable instructions that, when executed by a processor, cause the processor to execute the method as described herein. The features and example features of the 3^{rd} example embodiment are as described above with respect to various aspects of the 1^{st} and 2^{nd} example embodiments.

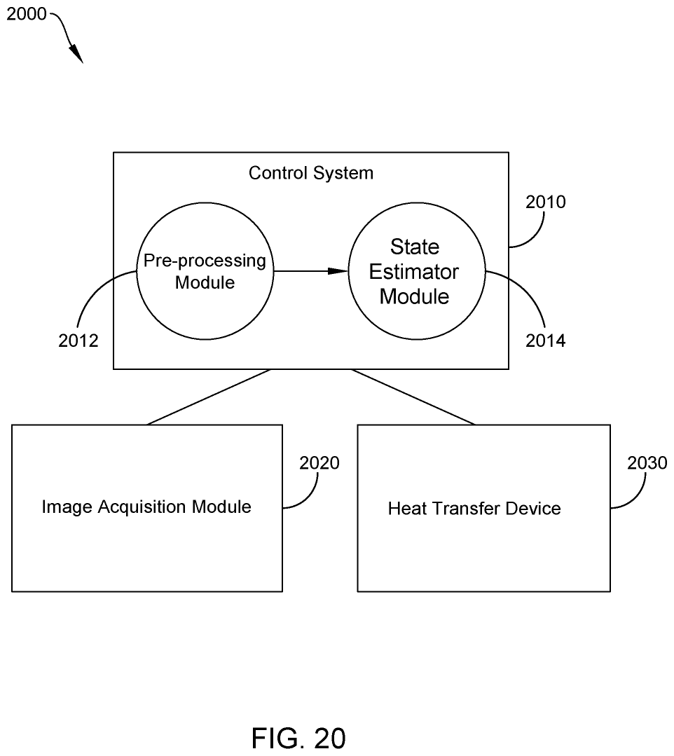

FIG. 20 depicts an exemplary system for controlling a phase transition of a sample, according to embodiments of the present disclosure. In general, as shown in FIG. 20, in an example embodiment, device 2000 includes control system 2010, operably connected to image acquisition module 2020, and heat transfer device 2030. In various embodiments, the control system 2010 further includes a state estimator module 2014. Optionally, control system 2010 can include pre-processing module 2012. The pre-processing module 2012 can be configured to process the data (or signals) received from imaging system 2020 and to provide to the pre-processed data to state estimator module 2014.

The heat transfer device 2030 may be adapted to be thermally connected with a sample having a first phase (e.g., solid phase, or another suitable phase) and a second phase (e.g., liquid phase, or another suitable phase), with the sample being initially in the first phase. The image acquisition module 2020 may be adapted to acquire an image of the sample. The control system 2010 may be operably (e.g., electrically, mechanically) connected with image acquisition module 2023 and/or heat transfer device 2030. The control system 2010 may be configured to, while a termination condition is not met: cause heat transfer between the heat transfer device and the sample, thereby causing a phase transition of the sample from the first phase to the second phase; cause the acquisition module to acquire the image of the sample; based on the image of the sample, determine the position of a boundary between the first phase and the second phase of the sample; and based on the determined position of the boundary, determine whether the termination condition is met.

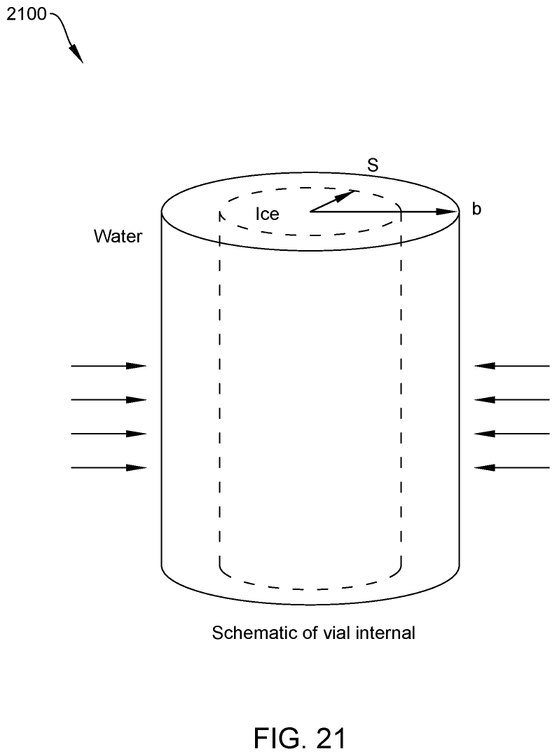

FIG. 21 depicts an exemplary sample having a first phase, a second phase, and a boundary of the phases, according to embodiments of the present disclosure. In various embodiments, the present disclosure may include a vial with a radius (e.g., 5 mm) and a height (e.g., 43 mm) initially containing a sample in a phase (e.g., biological cells frozen in ice), which is thermally connected with a heat transfer device, as described above. As the heat is transferred from the heat transfer device to the vial, the vial may include spatially (e.g., radially) varying temperature, as described in FIG. 1, resulting in another phase (e.g., biological cells melt in water), as well as a boundary between two phases.

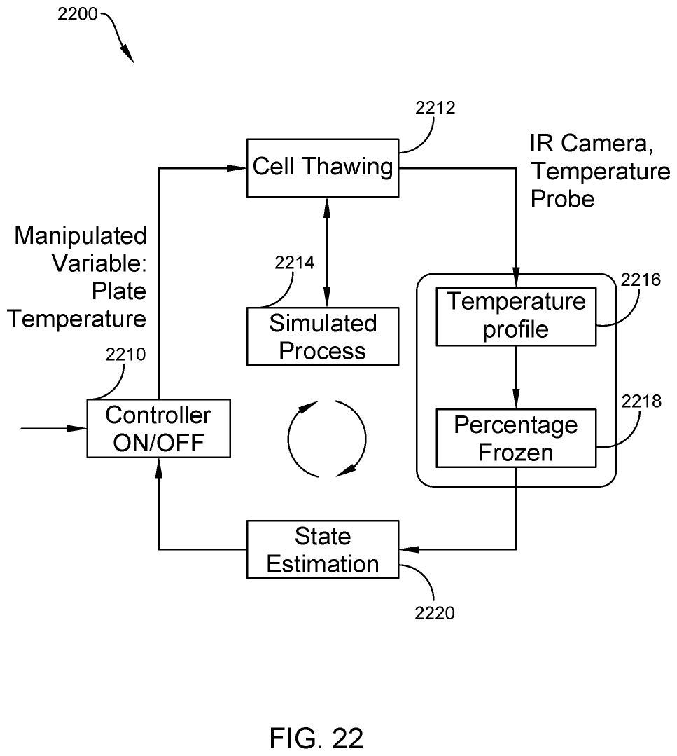

FIG. 22 depicts a flow diagram demonstrating an exemplary method for controlling a phase transition of a sample, according to embodiments of the present disclosure. In various embodiments, the method includes operating a controller 2210 (e.g., a control system), performing cell thawing 2212 (e.g., via a heat transfer device), performing simulated process 2214 that is operably connected with cell thawing 2212, obtaining data associated with temperature profile 2216 and percentage of frozen samples 2218, and/or performing state estimation 2220, and repeating the steps involving 2210, 2212, 2214, 2216, 2218, and/or 2220 until a termination condition is met.

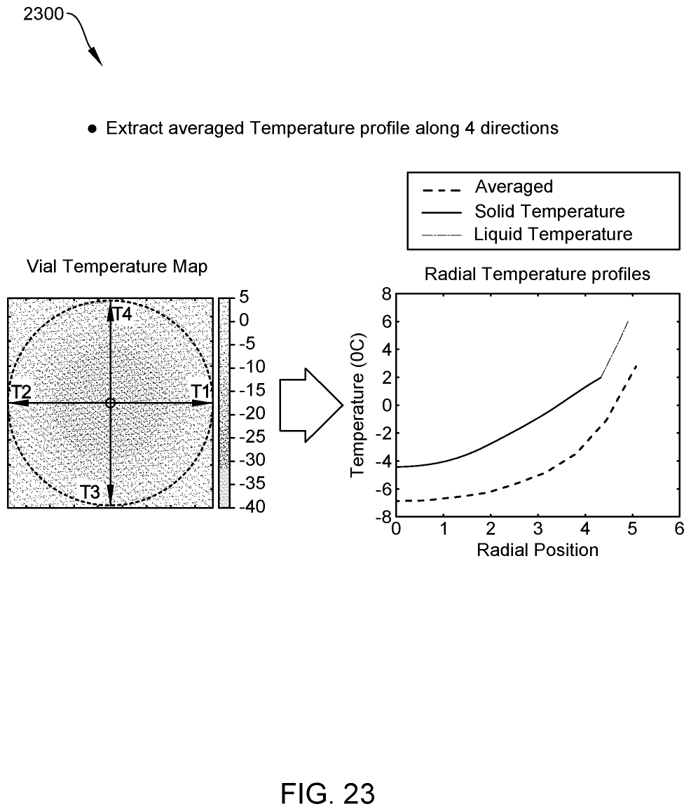

FIG. 23 depicts an exemplary variables and variable profiles during a phase transition of a sample, according to embodiments of the present disclosure. In various embodiments, as shown in FIG. 23, a variable profile includes a temperature map illustrating spatial distribution of temperature along one or more axial directions or radial directions. The spatial distribution of temperature may be associated with the temperature of one or more phases of a sample, or an averaged temperature of the sample.

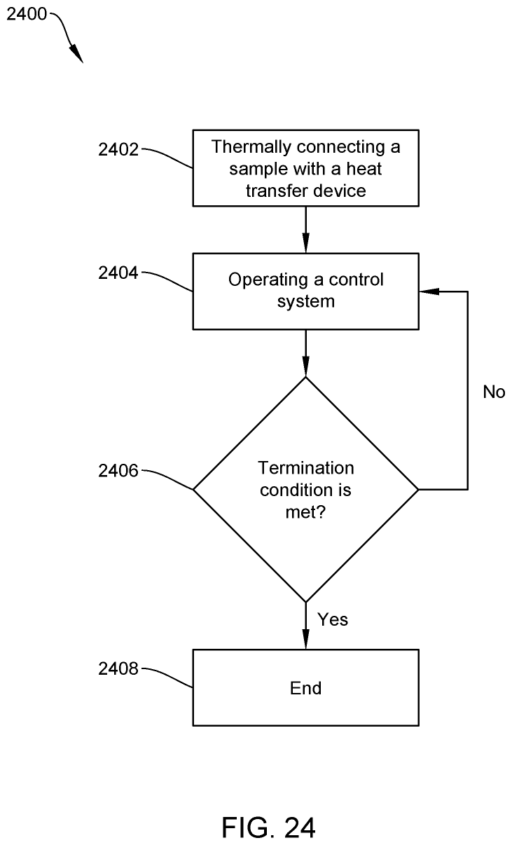

FIG. 24 depicts an exemplary method for controlling a phase transition of a sample, according to embodiments of the present disclosure. At step 2402, a sample may be thermally conducted with a heat transfer device. At step 2404, a control system may be operated. At step 2406, a termination condition is determined. If the termination condition is met, the method can be ended at step 2408. Otherwise, the method further includes returning to step 2404.

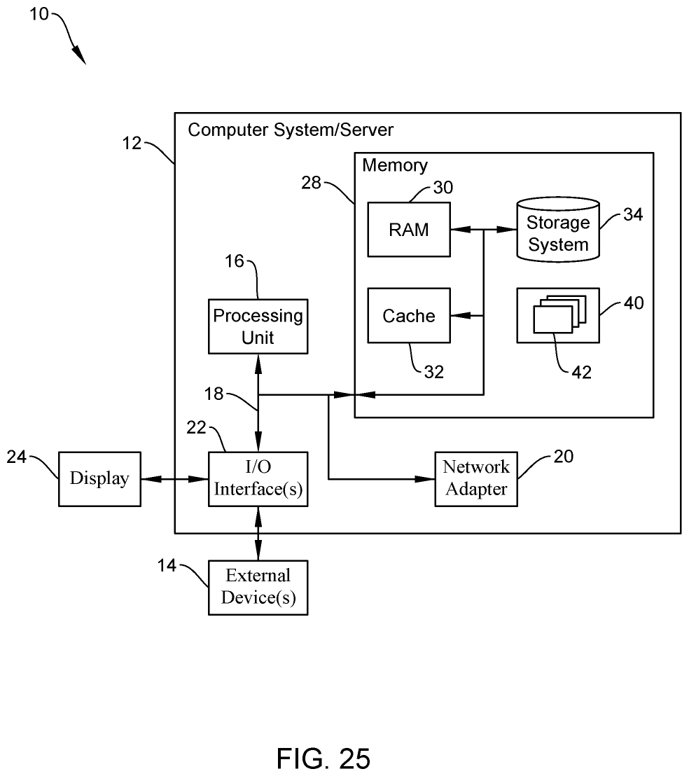

The control system of the devices described herein can be implemented as a computer node. an example of such a computing node is node 10 shown in FIG. 25.

Referring now to FIG. 25, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove, such as performing method 100 for example.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 25, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In various embodiments, one or more core (not pictured) is coupled to bus 18. In such embodiments, a core may receive data from or write data to memory 28 via bus 18. In various embodiments, a core may include one or more local controller, memory, or clock, for example as set forth elsewhere herein.

The present disclosure may be embodied as a device, a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A device, comprising:
a heat transfer device, adapted to be thermally connected with a sample, the sample having a first phase and a second phase, with the sample being initially in the first phase;
an image acquisition module adapted to acquire an image of the sample; and
a control system, operably connected to the heat transfer device and the image acquisition module,
wherein the control system is configured to, while a termination condition is not met:
cause heat transfer between the heat transfer device and the sample, thereby causing a phase transition of the sample from the first phase to the second phase;
cause the acquisition module to acquire the image of the sample;
based on the image of the sample, determine the position of a boundary between the first phase and the second phase of the sample; and
based on the determined position of the boundary, determine whether the termination condition is met.

2. The device of claim 1, wherein the first phase is solid and the second phase is liquid.

3. The device of claim 1, wherein the sample comprises cells.

4. The device of claim 1, wherein the termination condition is determined by the amount of the first phase and/or the second phase of the sample.

5. The device of claim 4, wherein the termination condition is determined by the ratio of the mass or the volume of the first phase to the second phase of the sample.

6. The device of claim 5, wherein the mass or volume of the first phase is about 5% of the sample.

7. The device of claim 1, wherein the image of the sample is an IR image, a visible range image, or a multispectral image.

8. The device of claim 1, wherein the control system further comprises a state estimator module configured to determine the position of a boundary between the first phase and the second phase of the sample.

9. The device of claim 8, wherein the state estimator module comprises a Luenberger observer.

10. The device of claim 1, wherein the image acquisition module is configured to acquire a plurality of images.

11. The device of claim 1, wherein the control system further comprises a pre-processing module configured to pre-process at least two of the plurality of the acquired images, and, based on the at least two of the acquired images, determine an approximated position of the boundary between the first phase and the second phase of the sample.

12. The device of claim 11, wherein the pre-processing module is further configured to determine, based on at least one of the plurality of the acquired images, at least one variable profile.

13. The device of claim 12, wherein the pre-processing module is operably connected to the state estimator module, and wherein the state estimator module is configured to determine the position of the boundary between the first phase and the second phase of the sample based on the approximated position of the boundary, and, optionally, based on the at least one variable profile.

14. The device of claim 12, wherein the at least one variable is temperature.

15. A method for controlling a phase transition of a sample, the method comprising:
thermally connecting a sample with a heat transfer device, the sample having a first phase and a second phase, with the sample being initially in the first phase;
operating a control system while a termination condition is not met, the control system being operably connected to the heat transfer device and an image acquisition module,
wherein operating the control module comprises:
causing heat transfer between the heat transfer device and the sample, thereby causing a phase transition from the first phase to the second phase;
causing the image acquisition module to acquire an image of the sample;
based on the image of the sample, determining the position of a boundary between the first phase and the second phase of the sample;
based on the determined position of the boundary, determining whether the termination condition is met.

16. The method of claim 15, wherein the first phase is solid and the second phase is liquid.

17. The method of claim 15, wherein the sample comprises cells.

18. The method of claim 15, wherein the termination condition is determined by the amount of the first phase and/or the second phase of the sample.

19. The method of claim 18, wherein the termination condition is determined by the ratio of the mass or the volume of the first phase to the second phase of the sample.

20. The method of claim 19, wherein the mass or volume of the first phase is about 5% of the sample.

21. The method of claim 15, wherein the image of the sample is an IR image, a visible range image, or a multispectral image.

22. The method of claim 15, wherein the control system comprises a state estimator module, and wherein operating the control system comprises causing the state estimator module to determine the position of a boundary between the first phase and the second phase of the sample.

23. The method of claim 22, wherein the state estimator module comprises a Luenberger observer.

24. The method of claim 21, wherein the image acquisition module is configured to acquire a plurality of images.

25. The method of claim 1, wherein the control system further comprises a pre-processing module operably connected to the state estimator module, the pre-processing module being configured to pre-process at least two of the plurality of the acquired images, and wherein operating the control system comprises causing the pre-processing module, based on the at least two of the acquired images, to determine an approximated position of the boundary between the first phase and the second phase of the sample.

26. The method of claim 25, wherein operating the control system further comprises causing the pre-processing module to determine, based on at least one of the acquired images, at least one variable profile.

27. The method of claim 26, wherein operating the control system comprises causing the state estimator module to determine the position of the boundary between the first phase and the second phase of the sample based on the approximated position of the boundary, and, optionally, based on the at least one variable profile.

28. The method of claim 25, wherein the at least one variable is temperature.

29. A non-transitory computer-readable medium having stored thereon computer-readable instructions that, when executed by a processor, cause the processor to execute a method comprising:
thermally connecting a sample with a heat transfer device, the sample having a first phase and a second phase, with the sample being initially in the first phase;
operating a control system while a termination condition is not met, the control system being operably connected to the heat transfer device and an image acquisition module,
wherein operating the control module comprises:
causing heat transfer between the heat transfer device and the sample, thereby causing a phase transition from the first phase to the second phase;
causing the image acquisition module to acquire an image of the sample;
based on the image of the sample, determining the position of a boundary between the first phase and the second phase of the sample;
based on the determined position of the boundary, determining whether the termination condition is met.
